(19) United States
(12) Patent Application Publication
(10) Pub. No.: US 2015/0290669 A1
(43) Pub. Date: Oct. 15, 2015

(54) Devices and Methods for Layer-by-Layer Assembly

(71) Applicant: Massachusetts Institute of Technology, Cambridge, MA (US)

(72) Inventors: Wei Li, Somerville, MA (US); Steven Andrew Castleberry, Boston, MA (US); Paula T. Hammond, Newton, MA (US)

(21) Appl. No.: 14/437,667

(22) PCT Filed: Oct. 25, 2013
(86) PCT No.: PCT/US2013/066980

§ 371 Date: Apr. 22, 2015

Related U.S. Application Data
(60) Provisional application No. 61/719,068, filed on Oct. 26, 2012.
(60) Provisional application No. 61/719,083, filed on Oct. 26, 2012.

(51) Int. Cl. B05C 3/02; B05D 1/18

(52) U.S. Cl. CPC B05C 3/02; B05D 1/18; Y10S 901/02

(57) ABSTRACT

Devices and associated methods are provided herein for creating arrays of thin films on a substrate utilizing a capillary force layer-by-layer assembly. Such devices and methods can be configured for forming one or more channels when the device is in operable contact with the substrate, each channel having an inlet reservoir at one end by which the coating material is introduced into the channel, wherein each channel is a lengthwise enclosure defined by a surface of the substrate on one side and one or more adjacent structures of the assembly surrounding the channel along its length. Provided devices and methods facilitate automated, precise manufacture of arrays of customized thin films for lab-on-a-chip biological and/or chemical assay products, for example. Additionally, provided devices and methods significantly reduce material waste, improves quality control, and expands the potential applications of LBL into new research space.

The present patent application claims the benefit of priority under 35 U.S.C. §119(e) to U.S. provisional patent application Ser. No. 61/719,068, filed on Oct. 26, 2012, the entire contents of which are herein incorporated by reference. The present patent application also claims the benefit of priority under 35 U.S.C. §119(e) to U.S. provisional patent application Ser. No. 61/719,083, filed Oct. 26, 2012, the entire contents of which are herein incorporated by reference.

### BACKGROUND

Layer-by-layer (LBL) assembly enables the tunable design and fine control of functional materials into films. These films are made up of alternating layers of material having different composition, for example, alternating layers of oppositely charged polyions or other complementary interacting species are deposited onto a substrate in sequence; their thickness can be controlled and is typically within the range of less than a nanometer to several micrometers. The technology has found diverse applications, including for example in the preparation of reactive membranes, drug delivery systems, and electrochemical and sensing devices. Thin film technologies have found diverse applications, including for example in the preparation of reactive membranes, drug delivery systems, and electrochemical and sensing devices.

### SUMMARY

Current apparatus and methods for preparing arrays of thin films typically employ dip coating, spin-coating, or spray-coating to deposit the bilayers of material. The present invention encompasses the recognition of the source of a problem with creating arrays of thin films via current techniques. Among other things, the present invention recognizes that such technologies can be limited, in that, for example, dip coating, spin-coating, and spray-coating methods may not provide satisfactory deposition precision, and/or because such methods may not allow compartmentalized, individualized customization of the individual thin films, for example that may be prepared in an array. Furthermore, the present invention encompasses the recognition that such current techniques may not be able to create complex viable film architectures, compositions, and morphologies which may be useful, or even necessary, for various desired applications. Additionally, the present invention encompasses the recognition that current technologies make it difficult to ensure non-sterile environments, which can be necessary to minimize contamination of the deposited films.

Over the past decade exciting new developments have indicated the power of LBL technologies, among other things in the context of biomedical applications, with examples ranging from bone tissue engineering to creating neurological interfaces. The LBL approach can enable direct incorporation of sensitive biologic drugs and/or in vivo controlled release from surfaces. However, the present invention encompasses the recognition that, as the field continues to expand to pursue new discoveries in cell biology and commercial translation in the pharmaceutical industry with applications covering reactive membranes, drug delivery systems, electrochemical and sensing devices, biologic delivery, and in probing surface-cell interactions, several engineering challenges need to be overcome. The present invention specifically encompasses the identification of the source of one or more problems with certain technologies for preparing LBL films. Moreover, the present invention provides various advantages, including permitting more simple in vitro analysis of films and/or improved quality control which, for example, can enable large-scale film screening.

Moreover, the present invention encompasses the recognition that many existing methods for constructing and evaluating LBL film assemblies rely on the individual production of single film samples. In many cases, such approaches may require multiple days to assemble one sample for testing, greatly impairing the potential for broader experimentation and film optimization. The present invention further appreciates that some systems for the delivery of expensive therapeutics present constraints to the number of samples that can be tested due to expense and the need to use significant quantities of solution for each data point; for example, current LBL assembly techniques typically require relatively large quantities of solution to create each bilayer. The present invention recognizes that, particularly when building LBL films with rare, scant, sensitive, or expensive materials, such as growth factors, cytokines, small molecule drugs, RNA, or DNA, amount of solution required can become an important, and even critical, consideration. The present invention therefore appreciates that there is a need for improved material efficiency in the production of LBL materials, among other things in order to reduce cost of investigations.

The present invention provides various technologies for production and/or characterization of LBL assemblies that, in various embodiments, overcome one or more limitations of other available approaches and/or provide new advantages with respect to them. For example, in some embodiments, the present invention provides a pump-free microfluidic approach for the high-throughput construction of multiple layer-by-layer films in parallel has been developed. In some embodiments, the present invention provides devices, for example including devices referred to herein as capillary flow Layer-by-Layer (“CF-LBL”) devices, that significantly reduce the amount of material used, in some embodiments requiring as little as 0.1% the amount of material as is typically utilized in conventional methods. This improvement is a significant advance for new applications of LBL films in biologic delivery and in probing surface-cell interactions. In some embodiments, such provided devices allow for the construction, investigation, and/or characterization of LBL films on virtually any planar surface, for example including glass, silicon, and/or plastics. In many embodiments, the simple layout of such provided devices allows for substantial customization and/or optimization of LBL assembly for specific applications.

In various embodiments, devices and associated methods are provided herein for creating arrays of thin films on a substrate utilizing capillary force layer-by-layer assembly (“CF-LBL”). For example, in some embodiments, devices and methods facilitate automated, precise manufacture of arrays of customized thin films for lab-on-a-chip biological and/or chemical assay products, for example.

In some embodiments, CF-LBL devices presented herein form a covered microchannel when placed against a substrate facilitating capillary force-driven movement of fluid through the microchannel. Liquid may be introduced to the channel, for example in some embodiments, by simple pipetting. A series of solution introduction, removal, and wash steps may be performed to deposit bilayers onto the substrate via the microchannel formed by a provided device.

In some embodiments, a provided device may be easily manufactured using standard soft lithography techniques, and can be made of inexpensive material, such as polydimethylsiloxane (PDMS), for example. In some embodiments, walls of a provided device can be shaped to form a wide variety of channel cross-sections, allowing deposition of films having complex morphologies or architectures.

In some aspects, the invention is directed to a device for depositing at least one layer of a coating material onto a substrate, assembly configured to form one or more channels when a provided device is in operable contact with the substrate, each channel having an inlet at one end by which the coating material is introduced into the channel, wherein each channel is a lengthwise enclosure defined by a surface of the substrate on one side and one or more adjacent structures of the assembly surrounding the channel along its length.

In some embodiments, at least one of the one or more channels of a provided device has a volume of no more than 10 microliters. In some embodiments, at least one of the one or more channels of a provided device has an average smallest dimension of less than 1000 microns. In certain embodiments, the smallest dimension is width and/or height.

In some embodiments, each of the one of the one or more channels of a provided device further has an outlet at an end opposite the inlet. In some embodiments, at least one of the one or more channels include one or more walls that is/are non-flat. In some embodiments, at least one of the one or more channels include one or more walls that are patterned. In some embodiments, at least one of the one or more channels include(s) one or more walls and/or wells. In some embodiments, at least one of the one or more channels include one or more walls includes one or more microstructures.

In some embodiments, assembly of a provided device includes use of at least one material selected from the group consisting of glass, polymer, co-polymer, urethanes, rubber, molded plastic, polymethyl-methacrylate (PMMA), polycarbonate, polytetrafluoroethylene (PTFE/TEFLON®), polyvinylchloride (PVC), polymethylsiloxane (PDMS), and polysulfone.

In some aspects, the invention is directed to methods for depositing at least one layer of a first coating material on a substrate, which methods may include contacting a device with the substrate, wherein the device comprises an assembly configured to form one or more channels, each channel having an inlet at one end by which the first coating material is introduced into the channel, wherein each channel is a lengthwise enclosure defined by a surface of the substrate on one side and one or more adjacent structures of the assembly surrounding the channel along its length; and introducing the first coating material into the one or more channels to produce a first layer of the coating material on the surface of the substrate.

In some embodiments, provided methods may further include maintaining the first coating material in the one or more channels in contact with the surface of the substrate for a predetermined period. In certain embodiments, the predetermined period is from about 1 minute to about 30 minutes. In certain embodiments, the predetermined period is up to about 1 hour.

Alternatively or additionally, in some embodiments, provided methods may further include removing an excess amount of the first coating material from the one or more channels. In certain embodiments, the step of removing is performed by introducing air into the channel or by applying a vacuum. In certain embodiments, the vacuum is less than about 15 psi, about 10 psi or about 5 psi.

Alternatively or additionally, in some embodiments, provided methods may further include introducing a second coating material via the inlet into the one or more channels to produce a second layer in contact with the first layer. In certain embodiments, the first and second coating materials are associated with one another via one or more non-covalent interactions. In certain embodiments, one or more non-covalent interactions are selected from the group consisting of electrostatic interactions, hydrogen bonding, affinity, metal coordination, physical adsorption, host-guest interactions, hydrophobic interactions, pi stacking interactions, van der Waals interactions, magnetic interactions, dipole-dipole interactions and combinations thereof. In certain embodiments, the method further include repeating the introduction of the first coating material into the one or more channels and, subsequently, repeating the introduction of the second coating material into the one or more channels, thereby forming a thin film comprising two bilayers on the substrate.

In certain embodiments, devices and methods are provided herein for building thin films using CF-LBL. For example, in some embodiments, a stencil configured to form multiple channels when the stencil is in operable contact with a substrate is provided. In certain embodiments, coating material is introduced into the multiple channels, and excess coating material is drawn away or otherwise exits the channels. After time passes, in some embodiments, a subsequent layer is deposited onto the first layer via the same channels, and the process may be continued thusly, building more and more layers, creating a customized array of individual, thin films. In certain aspects, methods may be automated, thereby increasing efficiency. In some embodiments, small channel size allows for capillary force-drawn movement of fluid through the channels, and smaller amounts of liquid are needed to create layers, compared with previous techniques.

In some embodiments, a provided multi-channel stencil may be easily manufactured using standard soft lithography techniques and can be made of inexpensive material, for example polydimethylsiloxane (PDMS). In some embodiments, walls of a provided stencil may also be shaped to form a wide variety of channel cross-sections, allowing deposition of films having complex morphologies or architectures.

In some aspects, a device for preparing an array of thin films via layer-by-layer assembly is provided. In some embodiments, a provided device includes a stencil configured to form multiple channels when the stencil is in operable contact with a substrate, wherein each channel has an inlet (e.g., an inlet reservoir) at one end by which coating material can be introduced into the channel, each channel has an outlet (e.g., an outlet reservoir) at an end opposite the inlet from which coating material may be drawn or may exit the channel, and each channel is a lengthwise enclosure defined by a surface of the substrate on one side and by one or more adjacent structures of the stencil surrounding the channel along its length; and a plurality of heads spaced in relation to each other to enable simultaneous or near-simultaneous introduction of coating material via the inlets into the plurality of channels formed when the stencil is in operable contact with the substrate.

In some embodiments, a provided device may further include a robotic arm; and a programmable controller configured to direct one or more of the following actions of the robotic arm: manipulation of peripheral labware, introduction of solution into multiple channels via a plurality of channel heads, and extraction of solution from one or more of the multiple channels via the channel outlets.

In some embodiments, a plurality of channel outlets of a provided stencil are connected to a common outlet reservoir. In certain embodiments, a provided stencil further includes a vacuum line connected to the common outlet reservoir for extraction of solution from the corresponding channels via vacuum. In certain embodiments, a provided stencil comprises at least one material selected from the group consisting of glass, polymer, co-polymer, urethanes, rubber, molded plastic, polymethyl-methacrylate (PMMA), polycarbonate, polytetrafluoroethylene (PTFE/TEFLON®), polyvinylchloride (PVC), polymethylsiloxane (PDMS), and polysulfone. In certain embodiments, each channel has a volume no more than about 10 microliters from inlet to outlet. In certain embodiments, each channel has an average width and/or depth of no more than about 1000 microns. In certain embodiments, a plurality of heads comprises pipette heads. In certain embodiment, the plurality of heads include 8, 16, 32, 96, or 384 heads.

According to some aspects, a stencil configured to form multiple channels when the stencil is in operable contact with a substrate for preparation of a plurality of layered thin films on the substrate via LBL assembly is provided, wherein each channel has an inlet (e.g., an inlet reservoir) at one end by which coating material can be introduced into the channel, and wherein each channel is a lengthwise enclosure defined by a surface of the substrate on one side and by one or more adjacent structures of the stencil surrounding the channel along its length. In certain embodiments, a provided stencil includes at least one material selected from the group consisting of glass, polymer, co-polymer, urethanes, rubber, molded plastic, polymethyl-methacrylate (PMMA), polycarbonate, polytetrafluoroethylene (PTFE/TEFLON®), polyvinylchloride (PVC), polymethylsiloxane (PDMS), and polysulfone. In some embodiments, each channel has an outlet (e.g., an outlet reservoir) at an end opposite the inlet, and wherein a plurality of the outlets are connected. In certain embodiments, each channel has a volume no more than about 10 microliters from inlet to outlet. In certain embodiments, each channel has an average width and/or depth of no more than about 1000 microns.

In some aspects, the invention is directed to methods for preparing an array of thin films via layer-by-layer assembly, which methods may include contacting a stencil with a substrate, wherein the stencil is configured to form multiple channels when the stencil is in operable contact with the substrate, wherein each channel has an inlet at one end by which coating material is introduced into the channel, each channel has an outlet at an end opposite the inlet from which coating material is drawn or exits the channel, and each channel is a lengthwise enclosure defined by a surface of the substrate on one side and by one or more adjacent structures of the stencil surrounding the channel along its length; introducing a first coating material into the multiple channels via a plurality of heads spaced in relation to each other to enable simultaneous or near-simultaneous introduction of coating material via the inlets into the plurality of channels formed when the stencil is in operable contact with the substrate, in order to deposit a first layer of the coating material in an array of individual strips (e.g. strips of any shape, not just rectangular) on the surface of the substrate; removing an excess amount of the first coating material from the multiple channels (e.g., removing excess coating material from inlet reservoirs of the multiple channels, leaving liquid inside the channel length between the inlet and outlet reservoirs); maintaining the first coating material in the multiple channels in contact with the surface of the substrate for a predetermined time period (e.g., thereby depositing the first layer of the first material onto the substrate); after maintaining the first coating material in the channels for the predetermined time period, removing an amount of the first coating material from the multiple channels via the outlets (e.g. by pulling a vacuum); washing the plurality of channels by introducing a washing fluid (e.g., deionized water) into the multiple channels and drawing the washing fluid out of the channels; introducing a second coating material into the multiple channels via a plurality of heads to deposit a second layer in contact with the first layer for each of the individual strips in the array, wherein the first and second coating materials are associated with one another via one or more non-covalent interactions; removing an excess amount of the second coating material from the multiple channels (e.g., removing excess coating material from inlet reservoirs of the multiple channels, leaving liquid inside the channel length between the inlet and outlet reservoirs; maintaining the second coating material in the multiple channels in contact with the previously-deposited first coating material for a predetermined period (e.g., may or may not be the same period of time as the first material), in order to form an array of thin bi-layer films on the substrate; and after maintaining the second coating material in the channels for the predetermined time period, removing an amount of the second coating material from the multiple channels via the outlets (e.g. by pulling a vacuum).

In some embodiments, provided methods may further include repeating the introduction of the first coating material into the plurality of channels and, subsequently, repeating the introduction of the second coating material into the plurality of channels (e.g., along with corresponding maintaining steps and removal steps), thereby forming thin films in the array comprising two bilayers on the substrate. In certain embodiments, arrays of thin films on the substrate are provided and may be configured to form a lab-on-a-chip biological and/or chemical assay product. In certain embodiments, provided methods further include directing a robotic arm to perform one or more of the following actions; manipulate peripheral labware, introduce solution into the multiple channels via the plurality of channel heads, extract solution from one or more of the multiple channels via the channel outlets. In certain embodiments, the step of removing the amount of the first coating material via the outlets is performed by introducing air into the channels or by applying a vacuum. In certain embodiments, a provided stencil includes at least one material selected from the group consisting of glass, polymer, co-polymer, urethanes, rubber, molded plastic, polymethyl-methacrylate (PMMA), polycarbonate, polytetrafluoroethylene (PTFE/TEFLON®), polyvinylchloride (PVC), polymethylsiloxane (PDMS), and polysulfone.

In some aspects, the invention is directed to methods for preparing an array of thin films via layer-by-layer assembly on a substrate, which methods may include contacting a stencil with a substrate, wherein the stencil is configured to form multiple channels when the stencil is in operable contact with the substrate, wherein each channel has an inlet at one end by which coating material is introduced into the channel, each channel has an outlet at an end opposite the inlet from which coating material is drawn or exits the channel, and each channel is a lengthwise enclosure defined by a surface of the substrate on one side and by one or more adjacent structures of the stencil surrounding the channel along its length; introducing a first coating material into the multiple channels via a plurality of heads spaced in relation to each other to enable simultaneous or near-simultaneous introduction of coating material via the inlets into the plurality of channels formed when the stencil is in operable contact with the substrate, thereby producing a first layer of the coating material in an array of individual strips (e.g. strips of any shape, not just rectangular) on the surface of the substrate; maintaining the first coating material in the multiple channels in contact with the surface of the substrate for a predetermined time period; introducing a second coating material into the multiple channels via a plurality of heads to produce a second layer in contact with the first layer for each of the individual strips in the array; and maintaining the second coating material in the multiple channels in contact with the previously-deposited first coating material for a predetermined period of time (e.g., may or may not be the same period of time as the first material), thereby forming an array of thin bi-layer films on the substrate. In certain embodiments, wherein the first coating material introduced into the multiple channels has a composition which varies among the individual channels (e.g., the first material introduced into one channel may not necessarily be the same first material that is introduced into another channel).

Other features, objects, and advantages of the present invention are apparent in the detailed description, drawings and claims that follow. It should be understood, however, that the detailed description, the drawings, and the claims, while indicating embodiments of the present invention, are given by way of illustration only, not limitation. Various changes and modifications within the scope of the invention will become apparent to those skilled in the art.

### BRIEF DESCRIPTION OF THE DRAWINGS

The objects and features of the invention can be better understood with reference to the drawings described below, and the claims.

FIG. 1 is a schematic drawing showing a top and side view of an exemplary device suitable for use in accordance with the present disclosure.

FIG. 2 is a schematic drawing illustrating a method for building LBL films using an exemplary device described herein.

FIG. 3 shows two series of photographs respectively demonstrating single channel pipetting and multi-channel pipetting with exemplary devices.

FIG. 4 is a set of graphs showing a comparison of LBL films fabricated using methods/devices provided herein to films fabricated by a conventional dipping method. Film thickness is plotted for films made by each method as a function of solution pH, as described in the Experimental Examples.

FIG. 5 is a graph and associated photos demonstrating the correlation between film thickness and the number of bilayers of a thin film prepared according to an illustrative embodiment.

FIG. 6 is a schematic illustrating a straight channel formed when a device is placed in contact with a substrate, as well as a non-straight channel and a channel with compartments.

FIG. 7 is a schematic illustrating patterned microstructures (e.g., posts and wells) inside channels, which can be used, for example, to create LBL films with 3D microstructures.

FIGS. 8 and 9 are schematic diagrams demonstrating the assemblage of LBL thin films on microparticles or printed nanoparticles in channels, according to an illustrative embodiment of the invention.

FIG. 10 is a series of photographs that illustrate a method for manufacturing parallel microstrips of LBL films using a multichannel pipet, according to an illustrative embodiment of the invention.

FIG. 11 is a schematic drawing that shows a top view and a side view of an exemplary device with three openings for introduction and/or extraction of coating solutions into and/or out of the channel, according to an illustrative embodiment of the invention.

FIG. 12 is a schematic drawing that shows a method of building LBL films using an exemplary device with three openings (e.g., holes), according to an illustrative embodiment of the invention.

FIG. 13 is a series of photographs illustrating exemplary stencil designs used in accordance with the present disclosure, along with two multi-pipetting arrangements.

FIG. 14 is a schematic drawing showing a top and side view of a single channel within a CF-LBL device, the red region is O₂ plasma treated.

FIG. 15 is a schematic drawing illustrating a method for building LBL films using an exemplary device described herein.

FIG. 16 shows two sets of photographs of multiple independent channels within a single CF-LBL device. The left image is fully O₂ plasma treated, the right selectively treated, scale=3 mm.

FIG. 17 is a graph demonstrating the correlation between film thickness and the number of bilayers for a sample of PAA/PAH_{FITC} LBL film.

FIG. 18 is a graph for screening LBL film architectures for material incorporation. Fluorescently labeled PAA is incorporated into LBL films with the polycations shown. Demonstrating a comparison of LBL films fabricated using methods/devices provided herein to films fabricated by a conventional dipping method. Film thickness is plotted for films made by each method as a function of solution pH, as described in the Experimental Examples.

FIG. 19 shows a pair of photographs demonstrating patterned microstructures that can be included within the channel and coated, scale=200 μm.

FIG. 20 shows a pair of photographs demonstrating a micro-patterned surface within the channel can be used to direct cell seeding, scale=100 μm.

FIG. 21 a graph exhibiting pH-dependent thickness behavior of sequentially absorbed layers of weak polyelectrolytes and investigation of in vitro cell interactions on polyelectrolyte multilayer (PEM) thin films.

FIG. 22 a graph showing cell density on films over time. Cells were initially seeded at 0.1 M/ml.

FIG. 23 a graph exhibiting average spread area of cells on different film architectures.

FIG. 24 a pair of graphs showing the effect of film thickness on cell density. Increasing bilayer thickness negatively impacted the total number of cells which initially seeded on the films.

FIG. 25 a pair of graphs showing plot of cell spread area vs. bilayer thickness.

FIG. 26 a pair of graphs showing the effect of PAA pH on cell density on the formed films.

FIG. 27 a table displaying the chemical structures of polycation repeat units.

FIG. 28 a set of graphs showing heat maps of cell density, cell spreading area, and fraction GFP of DNA transfection of cells cultured on films.

FIG. 29 a set of graphs showing cells on (BPEI/pEGFP) film cultured within the microchannels after 5, 6, and 7 days of culture, scale 50 μm.

FIG. 30 shows a series of photographs depicting 10 kDa BPEI.

FIG. 31 a set of photographs depicting cells cultured on all four sides of a channel coated with the LBL film by rotating a device while cells are being seeded, scale 75 μm.

FIG. 32 shows a FACS analysis and microscope imaging of cells cultured on the best candidate film from high throughput screening built on a microscope slide, scale 500 μm.

### DEFINITIONS

In order for the present disclosure to be more readily understood, certain terms are first defined below. Additional definitions for the following terms and other terms are set forth throughout the specification.

In this application, the use of “or” means “and/or” unless stated otherwise. As used in this application, the term “comprise” and variations of the term, such as “comprising” and “comprises,” are not intended to exclude other additives, components, integers or steps. As used in this application, the terms “about” and “approximately” are used as equivalents. Any numerals used in this application with or without about/approximately are meant to cover any normal fluctuations appreciated by one of ordinary skill in the relevant art. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

“Associated”: As used herein, the term “associated” typically refers to two or more entities in physical proximity with one another, either directly or indirectly (e.g., via one or more additional entities that serve as a linking agent), to form a structure that is sufficiently stable so that the entities remain in physical proximity under relevant conditions, e.g., physiological conditions. In some embodiments, associated moieties are covalently linked to one another. In some embodiments, associated entities are non-covalently linked. In some embodiments, associated entities are linked to one another by specific non-covalent interactions (i.e., by interactions between interacting ligands that discriminate between their interaction partner and other entities present in the context of use, such as, for example. streptavidin/avidin interactions, antibody/antigen interactions, etc.). Alternatively or additionally, a sufficient number of weaker non-covalent interactions can provide sufficient stability for moieties to remain associated. Exemplary non-covalent interactions include, but are not limited to, electrostatic interactions, hydrogen bonding, affinity, metal coordination, physical adsorption, host-guest interactions, hydrophobic interactions, pi stacking interactions, van der Waals interactions, magnetic interactions, electrostatic interactions, dipole-dipole interactions, etc.

“Biocompatible”: The term “biocompatible”, as used herein is intended to describe materials that do not elicit a substantial detrimental response in vivo. In certain embodiments, the materials are “biocompatible” if they are not toxic to cells. In certain embodiments, materials are “biocompatible” if their addition to cells in vitro results in less than or equal to 20% cell death, and/or their administration in vivo does not induce inflammation or other such adverse effects. In certain embodiments, materials are biodegradable.

“Biodegradable”: As used herein, “biodegradable” materials are those that, when introduced into cells, are broken down by cellular machinery (e.g., enzymatic degradation) or by hydrolysis into components that cells can either reuse or dispose of without significant toxic effects on the cells. In certain embodiments, components generated by breakdown of a biodegradable material do not induce inflammation and/or other adverse effects in vivo. In some embodiments, biodegradable materials are enzymatically broken down. Alternatively or additionally, in some embodiments, biodegradable materials are broken down by hydrolysis. In some embodiments, biodegradable polymeric materials break down into their component polymers. In some embodiments, breakdown of biodegradable materials (including, for example, biodegradable polymeric materials) includes hydrolysis of ester bonds. In some embodiments, breakdown of materials (including, for example, biodegradable polymeric materials) includes cleavage of urethane linkages.

“Hydrolytically degradable”: As used herein, “hydrolytically degradable” materials are those that degrade by hydrolytic cleavage. In some embodiments, hydrolytically degradable materials degrade in water. In some embodiments, hydrolytically degradable materials degrade in water in the absence of any other agents or materials. In some embodiments, hydrolytically degradable materials degrade completely by hydrolytic cleavage, e.g., in water. By contrast, the term “non-hydrolytically degradable” typically refers to materials that do not fully degrade by hydrolytic cleavage and/or in the presence of water (e.g., in the sole presence of water).

“Polyelectrolyte”: The term “polyelectrolyte”, as used herein, refers to a polymer which under some set of conditions (e.g., physiological conditions) has a net positive or negative charge. In some embodiments, a polyelectrolyte is or comprises a polycation; in some embodiments, a polyelectrolyte is or comprises a polyanion. Polycations have a net positive charge and polyanions have a net negative charge. The net charge of a given polyelectrolyte may depend on the surrounding chemical conditions, e.g., on the pH.

“Physiological conditions”: The phrase “physiological conditions”, as used herein, relates to the range of chemical (e.g., pH, ionic strength) and biochemical (e.g., enzyme concentrations) conditions likely to be encountered in the intracellular and extracellular fluids of tissues. For most tissues, the physiological pH ranges from about 7.0 to 7.4.

“Polypeptide”: The term “polypeptide” as used herein, refers to a string of at least three amino acids linked together by peptide bonds. In some embodiments, a polypeptide comprises naturally-occurring amino acids; alternatively or additionally, in some embodiments, a polypeptide comprises one or more non-natural amino acids (i.e., compounds that do not occur in nature but that can be incorporated into a polypeptide chain; see, for example, http://www.cco.caltech.edu/^{˜}dadgrp/Unnatstruct.gif, which displays structures of non-natural amino acids that have been successfully incorporated into functional ion channels) and/or amino acid analogs as are known in the art may alternatively be employed). In some embodiments, one or more of the amino acids in a protein may be modified, for example, by the addition of a chemical entity such as a carbohydrate group, a phosphate group, a farnesyl group, an isofarnesyl group, a fatty acid group, a linker for conjugation, functionalization, or other modification, etc.

“Polysaccharide”: The term “polysaccharide” refers to a polymer of sugars. Typically, a polysaccharide comprises at least three sugars. In some embodiments, a polypeptide comprises natural sugars (e.g., glucose, fructose, galactose, mannose, arabinose, ribose, and xylose); alternatively or additionally, in some embodiments, a polypeptide comprises one or more non-natural amino acids (e.g., modified sugars such as 2′-fluororibose, 2′-deoxyribose, and hexose).

“Substantially”: As used herein, the term “substantially”, and grammatical equivalents, refer to the qualitative condition of exhibiting total or near-total extent or degree of a characteristic or property of interest. One of ordinary skill in the art will understand that biological and chemical phenomena rarely, if ever, go to completion and/or proceed to completeness or achieve or avoid an absolute result.

### DETAILED DESCRIPTION OF CERTAIN EMBODIMENTS

It is contemplated that compositions, systems, devices, methods, and processes of the claimed invention encompass variations and adaptations developed using information from the embodiments described herein. Adaptation and/or modification of the compositions, systems, devices, methods, and processes described herein may be performed by those of ordinary skill in the relevant art.

Throughout the description, where articles, devices, and systems are described as having, including, or comprising specific components, or where processes and methods are described as having, including, or comprising specific steps, it is contemplated that, additionally, there are articles, devices, and systems of the present invention that consist essentially of, or consist of, the recited components, and that there are processes and methods according to the present invention that consist essentially of, or consist of, the recited processing steps.

Similarly, where articles, devices, and compositions are described as having, including, or comprising specific compounds and/or materials, it is contemplated that, additionally, there are articles, devices, mixtures, and compositions of the present invention that consist essentially of, or consist of, the recited compounds and/or materials.

It should be understood that the order of steps or order for performing certain action is immaterial so long as the invention remains operable. Moreover, two or more steps or actions may be conducted simultaneously.

The mention herein of any publication, for example, in the Background section, is not an admission that the publication serves as prior art with respect to any of the claims presented herein. The Background section is presented for purposes of clarity and is not meant as a description of prior art with respect to any claim. Headers are provided for organizational purposes and are not meant to be limiting.

In some aspects of the present disclosure, a capillary force device for depositing at least one layer of a coating material on a surface is described.

### Devices and Methods

In some embodiments, the present invention provides devices for depositing at least one layer of a coating material on a substrate surface. In some embodiments, a provided device includes an assembly configured to form one or more channels when a provided device is in operable contact with the substrate, each channel having an inlet reservoir at one end by which the coating material is introduced into the channel, wherein each channel is a lengthwise enclosure defined by a surface of the substrate on one side and one or more adjacent structures of the assembly surrounding the channel along its length.

Various materials known in the art can be used to make a capillary force device depending on the methods of fabrication and uses. Exemplary materials for a capillary force device includes, but are not limited to, glass, polymer, co-polymer, urethanes, rubber, molded plastic, polymethyl-methacrylate (PMMA), polycarbonate, polytetrafluoroethylene (PTFE/TEFLON®), polyvinylchloride (PVC), polymethylsiloxane (PDMS), and polysulfone.

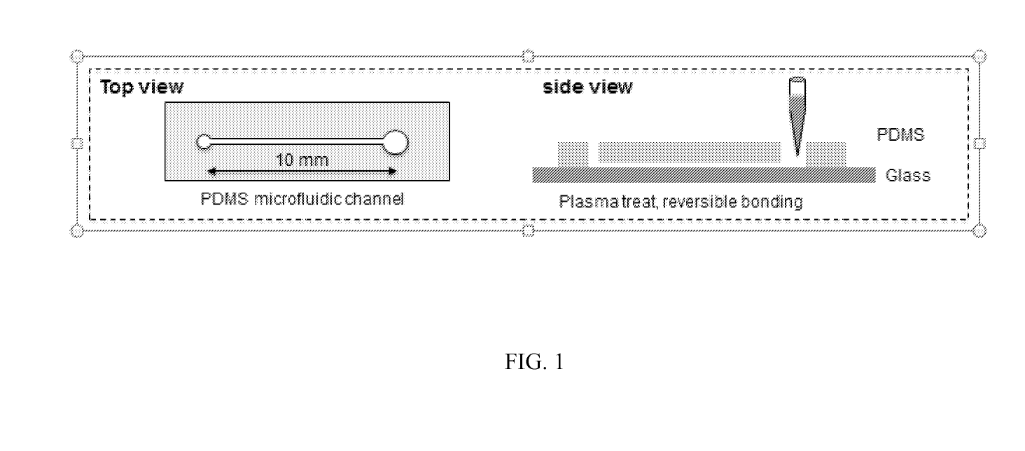

FIG. 1 shows the top and side view of a single channel of an exemplary device according to the present disclosure. In this example, the device is made from polydimethysiloxane (PDMS) using a standard soft lithography technique and forms a microfluidic channel when it is placed in contact with a substrate. The width and height of the microchannel may vary from tens of micrometers to hundreds of micrometers, depending on the application; while the length of the microchannel is typically from a few millimeters to tens of millimeters (the example channel shown in FIG. 1 has a length of 10 mm). The channel connects two openings, used as inlet and outlet reservoirs for the delivery of polyelectrolyte (PE) solutions. Such a device can be placed on top of and/or bonded to a negatively charged surface of a flat or non-flat substrate (e.g., glass, silicon, metal, or other polymer material) to form the channel. An initial substrate surface charge can be created by oxygen plasma treatment of the surface, which also sterilizes the surface.

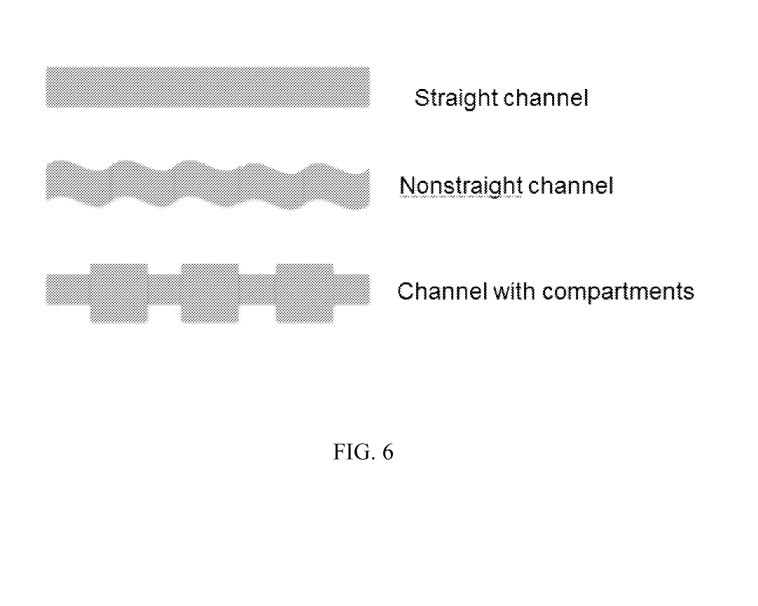

Channels described herein can be of any shape or dimension as long as they remain operable. As shown in FIG. 6, in some embodiments, the channel is linear (e.g., straight). In addition or alternatively, the channel can be non-straight. In some embodiments, the channels is a combination of linear and non-linear sections (e.g., the cross-section of the channel may vary in size, dimension, and/or shape along the length of the channel). According to the present disclosure, channels formed by a given device can be identical or different from one another.

In some embodiments, the smallest dimension or at least one dimension of a channel (e.g., its height, its width, its depth, its circumference, its diameter, or its thickness) may be about or less than 1000 μm, 800 μm, 500 μm, 400 μm, 300 μm, 200 μm, 180 μm, 150 μm, 120 μm, 110 μm, 100 μm, 90 μm, 80 μm, 70 μm, 60 μm, 50 μm, 40 μm, 30 μm, 20 μm, 10 μm, 5 μm, 2 μm, or even 1 μm. In some embodiments, the smallest dimension or at least one dimension of a channel may be in a range of about 1000 μm to about 5 μm, about 200 μm to about 20 μm, about 100 μm to about 50 μm, or any two values above. In some embodiments, the dimension of a channel is an average dimension, and the average dimension of a channel can be in a range as mentioned above.

The smallest dimension or at least one dimension of a channel may be a width and/or a height. Together with a width/height, a length (e.g., a few to tens of millimeters) of a channel, as appreciated by a person with ordinary skill in the art, can dictate the volume of the channel.

A volume of a channel can vary depending on a sample size (e.g., coating material) and/or a particular application. In some embodiments, the volume of a channel may be about or less than 100 μL, 50 μL, 10 μL, 1 μL, 500 nL, 200 nL, 100 nL, 90 nL, 80 nL, 70 nL, 60 nL, 50 nL, 40 nL, 30 nL, 20 nL, 10 nL, 5 nL, 2 nL, or even 1 nL. In some embodiments, the volume of a channel may be in a range of about 1000 μL to about 1 nL, about 10 μL to about 5 nL, about 100 nL to about 10 nL or any two values above.

In accordance with the present disclosure, walls (e.g., side walls, a ceiling and a bottom) of a channel formed when a provided device is placed in contact with a substrate can be independently of any shape/design. In some embodiments, the capillary flow device is configured such that the surface of the substrate that a provide device is in contact with forms one or more walls (or portions thereof) of the capillary channel through which fluid flows during layer deposition. For example, the substrate may form the bottom of the channel.

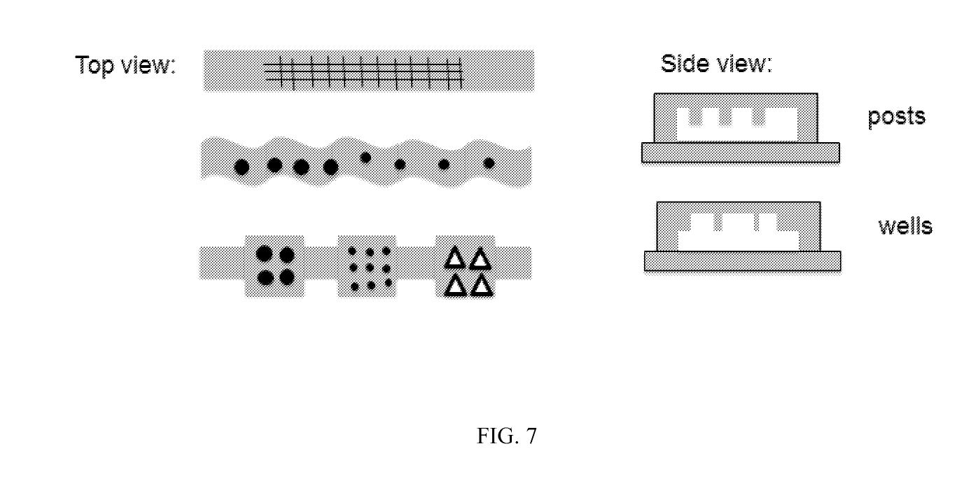

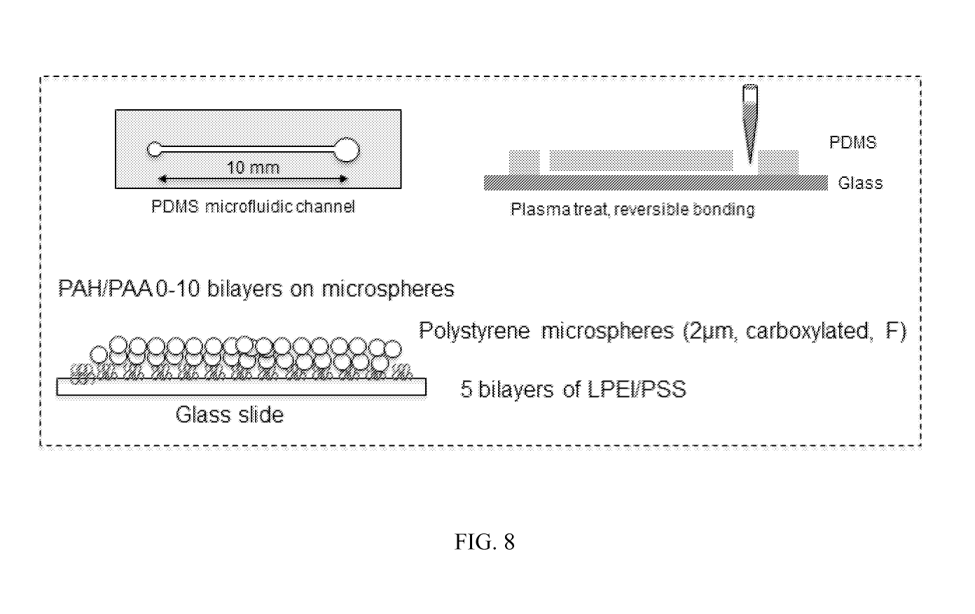

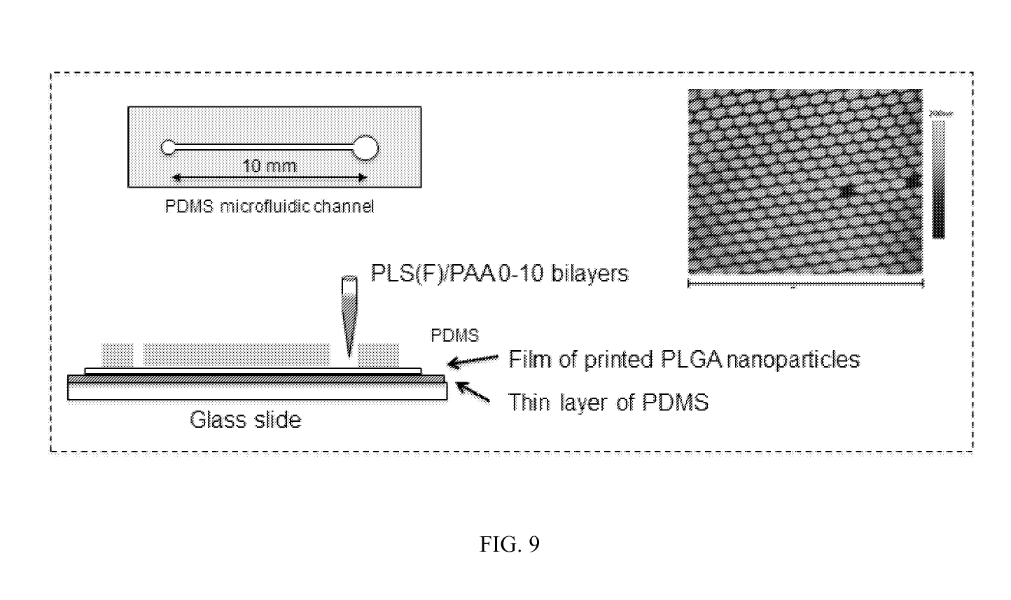

In some embodiments, walls can be flat or non-flat. In some embodiments, walls are patterned. For examples, patterned surfaces contain posts and/or wells as shown in the side view schematics of FIG. 7. A patterned surface can be defined by one or more microstructures. Exemplary shapes of microstructures include spheres, triangles, squares, circles, rectangles, stars, rods, cubes, cones, pyramids, cylinders, tubes, rings, tetrahedrons, hexagons, octagons, cages, or any irregular shapes. Walls may be consistent or may vary in dimension and/or shape along the length of the channel. FIGS. 8 and 9 demonstrate assembly of LBL thin films on microparticles or printed nanoparticles in channels, according to an illustrative embodiment of the invention.

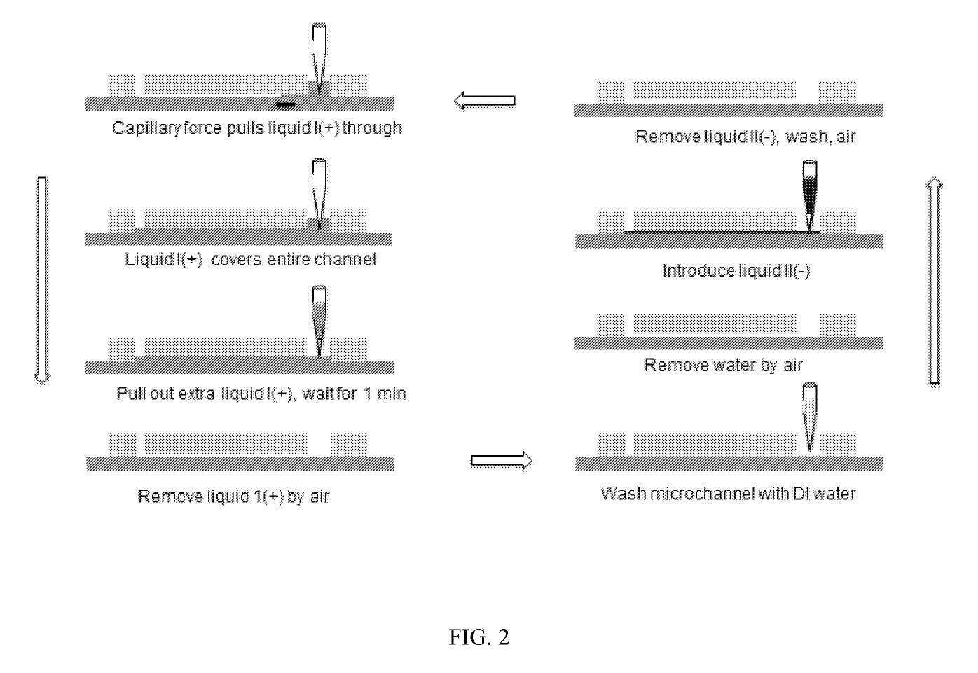

Now referring to FIG. 2 as an example, to build a LBL film, polyelectrolyte (PE) solution I (e.g. a positively charged species) is first introduced to the inlet by a standard pipet tip, and is subsequently drawn into the channel by capillary force. As the channel is filled with the liquid solution, extra polyelectrolyte solution I in the inlet reservoir is pulled out of the device and back into the pipet tip and returned to its original container. The capillary force holds the liquid in the channel, while only liquid solution from inlet reservoir is removed, leaving the channel covered with polyelectrolyte solution I. The volume of polyelectrolyte solution I inside the microchannel is typically at a nanoliter to microliter scale, e.g., from 0.1 nanoliter to 100 microliters. Polyelectrolyte solution I stays in the channel for a period of time (e.g., 1-60 minutes) so that PE absorbs onto the substrate. The channel is then washed to remove excess non-adsorbed polyelectrolyte. The water remaining in the assembly is then removed using a low pressure gas purge. This results in an open channel available for the introduction of the next polyelectrolyte solution into the channel and adsorption of the polyelectrolyte onto the previous layer. Polyelectrolyte solution II (e.g. negative charged species) is introduced to the channel using the same method described above. The alternating adsorption of two polyelectrolytes results in a bilayer of polyelectrolyte on the substrate. Repeating this process can build films with a desired number of bilayers. After completion of building the film(s), the PDMS sheet can be easily removed from the substrate, leaving the microstrip of LBL film on the substrate. PDMS can also be left attached to the substrate, forming an open channel coated with the created film(s).

According to the present disclosure, a device provided herein is contacted with a substrate, and a coating material introduced into the channel is maintained in contact with the substrate or the previously-deposited layer for a predetermined period. For example, a predetermined period can be less than about 2 hours, about 1 hour, about 50 minutes, about 40 minutes, about 30 minutes, about 20 minutes, about 20 minutes, about 10 minutes, about 5 minutes, or even about 1 minute.

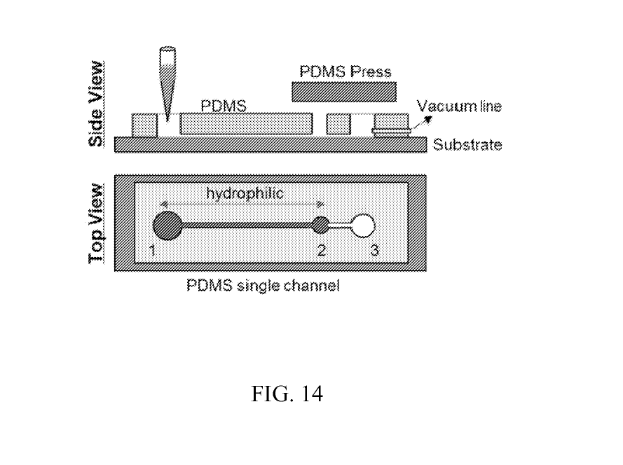

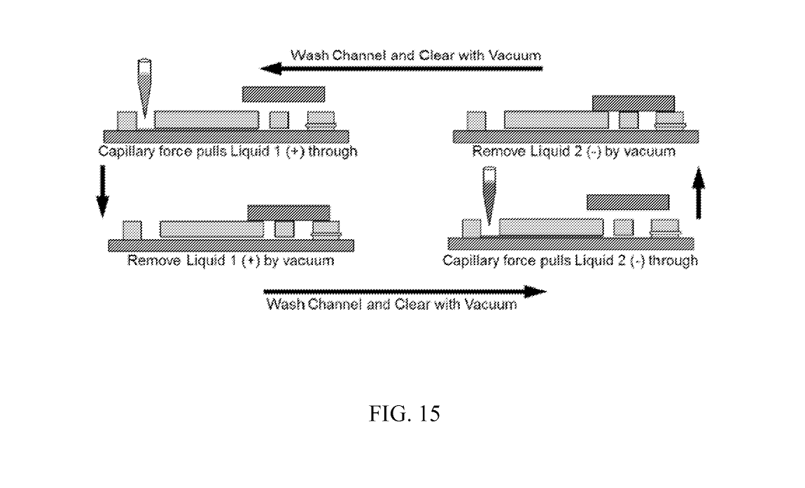

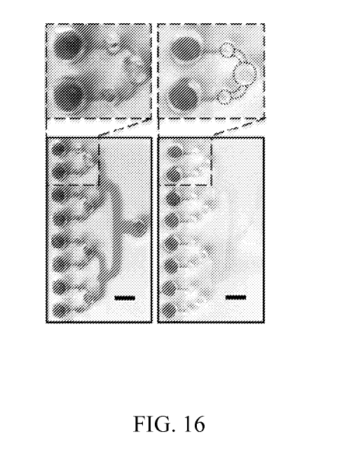

In some embodiments a device of the present invention consists of an array of microchannels formed by bonding of a PDMS mold to an oxygen plasma treated substrate (e.g., glass, polystyrene, etc.). As shown in FIG. 14, each microchannel is comprised of a main channel where material from solution adsorbs onto the substrate and three openings: (1) an inlet well where a liquid droplet can be placed and recovered, (2) a capillary flow break well, and (3) an exit well. Each channel is independent and is not exposed to material in neighboring channels. Channel widths ranging from 50 μm to 1.2 mm and lengths from 1 mm to 15 mm were able to fill using capillary flow and were capable of assembling uniform LBL films. In some embodiments, a provided device is designed so that hundreds of microchannels can be assembled in an array for high-throughput screening. The capillary flow used to fill the channel is controlled by applying plasma treatment to select portions of a provided device. Additionally and to show the importance of surface preparation, FIG. 16 shows two photographs of multiple independent channels within a single CF-LBL device. The left image is fully O₂ plasma treated, the right selectively treated. After deposition of material from solution for a pre-determined amount of time the channel is cleared by vacuum, as shown in FIG. 15.

In some embodiments, CF-LBL provides a pump-free microfluidic approach for high-throughput construction of multiple layer-by-layer films in parallel. A provided device may significantly reduce the amount of material used, requiring as little as 0.1% the amount of material as conventional methods. A device as provided herein allows for the construction and investigation of LBL films on virtually any planar surface including glass, silicon, and plastics. Films of varying compositions, morphologies, and architectures may be rapidly produced and screened for material and biological properties. The layout of channels can be based on 96- and 384-well plate dimensions to combine with liquid handling robots and programmable stages for high-throughput screening.

### Coating Materials and LBL Films

In some embodiments, one or more layers of films can be made using CF-LBL methods and devices provided in accordance with the present disclosure. In some embodiments, provided methods and devices are particularly useful to make LBL films. In the LBL process, alternating charged or other complementary interacting species are deposited onto a substrate in sequence enabling the tunable design and fine control of functional materials into nano-scale thin films. Detailed description of exemplary LBL films can be found in U.S. Pat. No. 7,112,361, the contents of which are incorporated herein by reference.

In some embodiment, LBL films may have various film architectures, film materials, film thickness, surface chemistry, and/or incorporation of agents, according to the design and application of coated devices. In general, LBL films comprise multiple layers. In certain embodiments, LBL films are comprised of multilayer units; each unit comprising individual layers. In accordance with some embodiments of the present disclosure, individual layers in an LBL film interact with one another. In particular, a layer in an LBL film may comprise an interacting moiety, which interacts with a moiety from an adjacent layer, so that a first layer associates with a second layer adjacent to the first layer, wherein each layer contains at least one interacting moiety.

In some embodiments, adjacent layers are associated with one another via non-covalent interactions. Exemplary non-covalent interactions include, but are not limited to, electrostatic interactions, hydrogen bonding, affinity, metal coordination, physical adsorption, host-guest interactions, hydrophobic interactions, pi stacking interactions, van der Waals interactions, magnetic interactions, dipole-dipole interactions and combinations thereof.

In some embodiments, an interacting moiety is a charge, positive or negative. LBL films may be comprised of multilayer units with alternating layers of opposite charge, such as alternating anionic and cationic layers. In some embodiments, an interacting moiety is a hydrogen bond donor or acceptor. In some embodiments, an interacting moiety is a complementary moiety for specific binding such as avidin/biotin. In various embodiments, more than one interactions can be involve in the association of two adjacent layers. For example, an electrostatic interaction can be a primary interaction; a hydrogen bonding interaction can be a secondary interaction between the two layers.

In some embodiments, an LBL film include a plurality of a single unit (e.g., a bilayer unit, a tetralayer unit, etc.). In some embodiments, an LBL film is a composite that include more than one units. For example, more than one units can have be different in film materials (e.g., polymers), film architecture (e.g., bilayers, tetralayer, etc.), film thickness, and/or agents that are associated with one of the units. In some embodiments, an LBL film is a composite that include more than one bilayer units, more than one tetralayer units, or any combination thereof. In some embodiments, an LBL film is a composite that include a plurality of a single bilayer unit and a plurality of a single tetralayer unit. In some embodiments, the number of a multilayer unit is 3, 5, 10, 20, 30, 40, 50, 60, 70, 80, 90, 100, 150, 200, 300, 400 or even 500.

LBL films may have various thickness depending on methods of fabricating and applications. In some embodiments, an LBL film has an average thickness in a range of about 1 nm and about 100 μm. In some embodiments, an LBL film has an average thickness in a range of about 1 μm and about 50 μm. In some embodiments, an LBL film has an average thickness in a range of about 2 μm and about 5 μm. In some embodiments, the average thickness of an LBL film is or more than about 1 nm, about 100 nm, about 500 nm, about 1 μm, about 2 μm, about 3 μm, about 4 μm, about 5 μm, about 10 μm, bout 20 μm, about 50 μm, about 100 μm. In some embodiments, an LBL film has an average thickness in a range of any two values above.

A coating material used in accordance with the present disclosure to make an individual layer can contain a polymeric material. In some embodiments, the polymeric material is degradable (e.g., hydrolytically degradable) or non-degradable. In some embodiments, the polymeric material is natural or synthetic. In some embodiments, the polymeric material is a polyelectrolyte. In some embodiments, the polymeric material is a polypeptide. In some embodiments, the polymeric material has a relatively low molecular weight. In some embodiments, the polymeric material is an agent for delivery.

In certain embodiments, a polymer of an individual layer includes a degradable polyelectrolyte. In some embodiments, decomposition of LBL films made using the provided methods and device is characterized by substantially sequential degradation of at least a portion of the polyelectrolyte layers that make up LBL films. Degradation may be at least partially hydrolytic, at least partially enzymatic, at least partially thermal, and/or at least partially photolytic. Degradable polyelectrolytes and their degradation byproducts may be biocompatible so as to make LBL films amenable to use in vivo.

Degradable polyelectrolytes that can be used in LBL films disclosed herein, include, but are not limited to, hydrolytically degradable, biodegradable, thermally degradable, and photolytically degradable polyelectrolytes. Hydrolytically degradable polymers may include for example, certain polyesters, polyanhydrides, polyorthoesters, polyphosphazenes, and polyphosphoesters. Biodegradable polymers may include, for example, certain polyhydroxyacids, polypropylfumerates, polycaprolactones, polyamides, poly(amino acids), polyacetals, polyethers, biodegradable polycyanoacrylates, biodegradable polyurethanes and polysaccharides. For example, specific biodegradable polymers that may be used include, but are not limited to, polylysine, poly(lactic acid) (PLA), poly(glycolic acid) (PGA), poly(caprolactone) (PCL), poly(lactide-co-glycolide) (PLG), poly(lactide-co-caprolactone) (PLC), and poly(glycolide-co-caprolactone) (PGC). This is an exemplary, not comprehensive, list of biodegradable polymers. Co-polymers, mixtures, and adducts of these polymers may also be employed.

A coating material used in accordance with the present disclosure can comprise one or more agents for delivery. In some embodiments, one or more agents are simply embedded in or associated with a coating material. In some embodiments, an agent for delivery is released when one or more layers of a LBL film are decomposed. Additionally or alternatively, an agent may be released by diffusion.

Exemplary agents include therapeutic agents (e.g. antibiotics, NSAIDs, glaucoma medications, angiogenesis inhibitors, neuroprotective agents), cytotoxic agents, diagnostic agents (e.g. contrast agents; radionuclides; and fluorescent, luminescent, and magnetic moieties), prophylactic agents (e.g. vaccines), and/or nutraceutical agents (e.g. vitamins, minerals, etc.). Without being bound to any particular theory, methods and devices described herein have the following advantages and improvements over existing LBL methods/devices.

### Multichannel Devices and Methods

Various materials known in the art can be used to make multi-channel stencils as described herein, depending on the methods of fabrication and uses. Exemplary materials for the stencil include, but are not limited to, glass, polymer, co-polymer, urethanes, rubber, molded plastic, polymethyl-methacrylate (PMMA), polycarbonate, polytetrafluoroethylene (PTFE/TEFLON®), polyvinylchloride (PVC), polymethylsiloxane (PDMS), and polysulfone. The stencil may be used together with a substrate (e.g., a flat substrate) made of glass, silicon, metal, polymer material, ceramic, or other material.

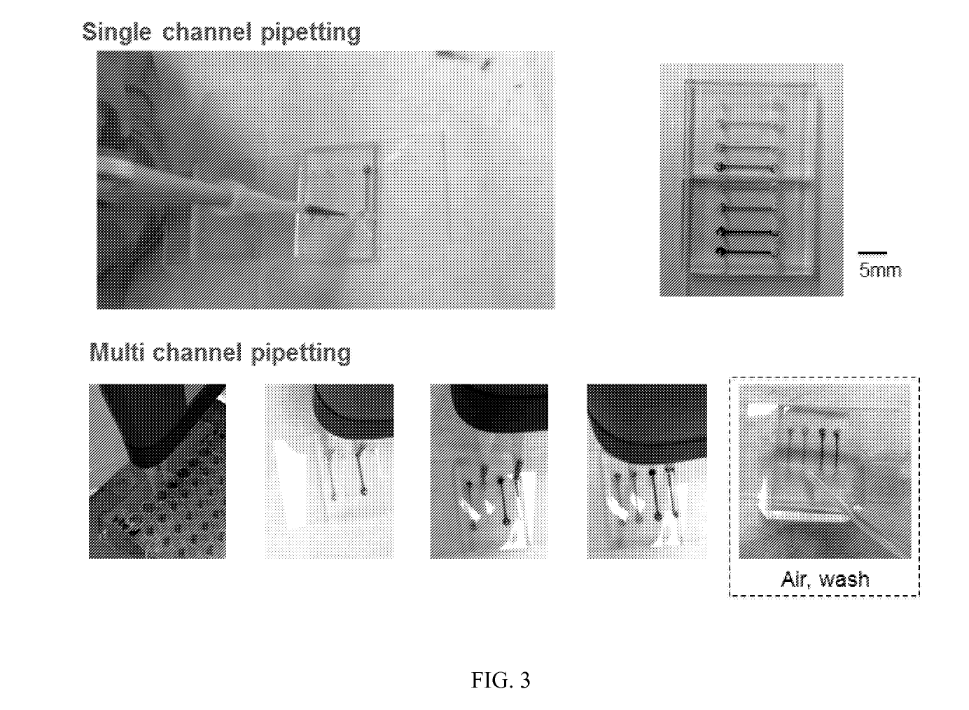

In some embodiments, devices and methods described herein allow high throughput preparation of LBL films. Stencils described herein may be manufactured using current soft lithography techniques, and can be used as described herein to prepare arrays of thin films, such that a large number of individual films can be prepared at once, and multiple devices can be created in parallel. For example, in certain embodiments, inlet reservoirs of the described stencils can be prepared to match the distance between pipet tips of a commercial multichannel pipet, thereby allowing the filling of multiple channels with solution(s) at once, and/or the extraction of solution from multiple channels at once. The photographs of FIG. 3 demonstrate single and multichannel pipetting with CF-LBL devices and methods of the present invention. Furthermore, methods described herein may be employed with programmable computer-assisted liquid handling systems, to further automate the introduction and extraction of various solutions that are used in depositing layers of the thin films.

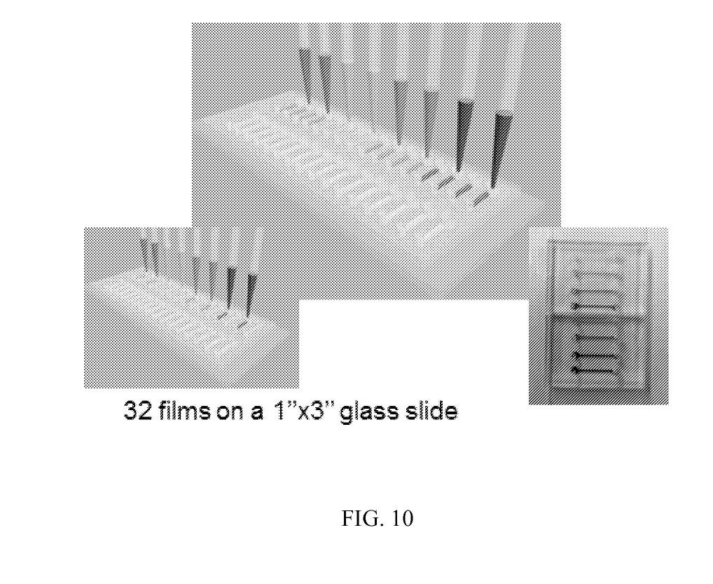

In certain embodiments, devices and methods described herein can be used to introduce different coating materials (e.g., different polyelectrolyte solutions) into individual channels of the stencil at the same time or at different times, thereby producing an array of a variety of different thin films on a given substrate. For example, using provided methods and devices, 32 separate film architectures can easily be built on a single 1″×3″ glass slide using a multichannel pipet as show by the series of photographs in FIG. 10.

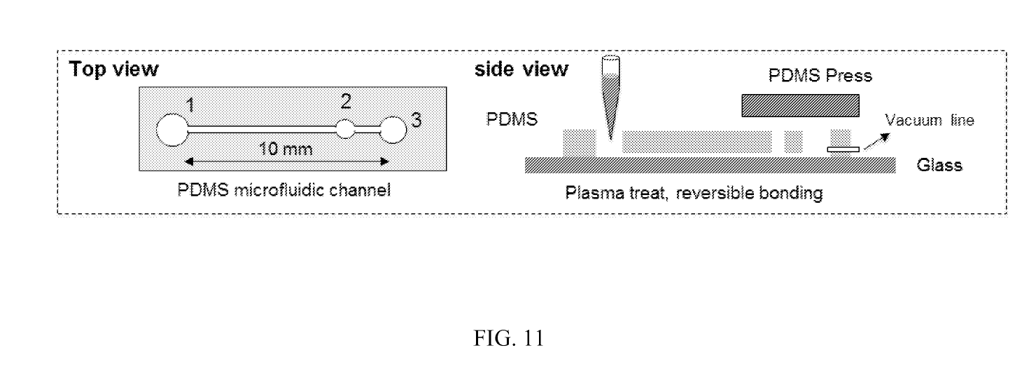

FIG. 11 shows the top and side view of one channel of an exemplary multiple-channel device, which is made from polydimethysiloxane (PDMS) using a standard soft lithography technique. This microchannel has three openings (e.g., holes), used as inlet and outlet reservoirs for the delivery of polyelectrolyte (PE) solutions. In some embodiments, a vacuum line is provided connecting to the third hole and applying vacuum for solution removal during deposition steps. Such a device can be placed on top of and/or bonded to a negatively charged surface of a flat or non-flat substrate (e.g., glass, silicon, metal, ceramic or polymer materials). In some aspects. an initial surface charge can be created by oxygen plasma treatment of the surface, which also sterilizes the surface.

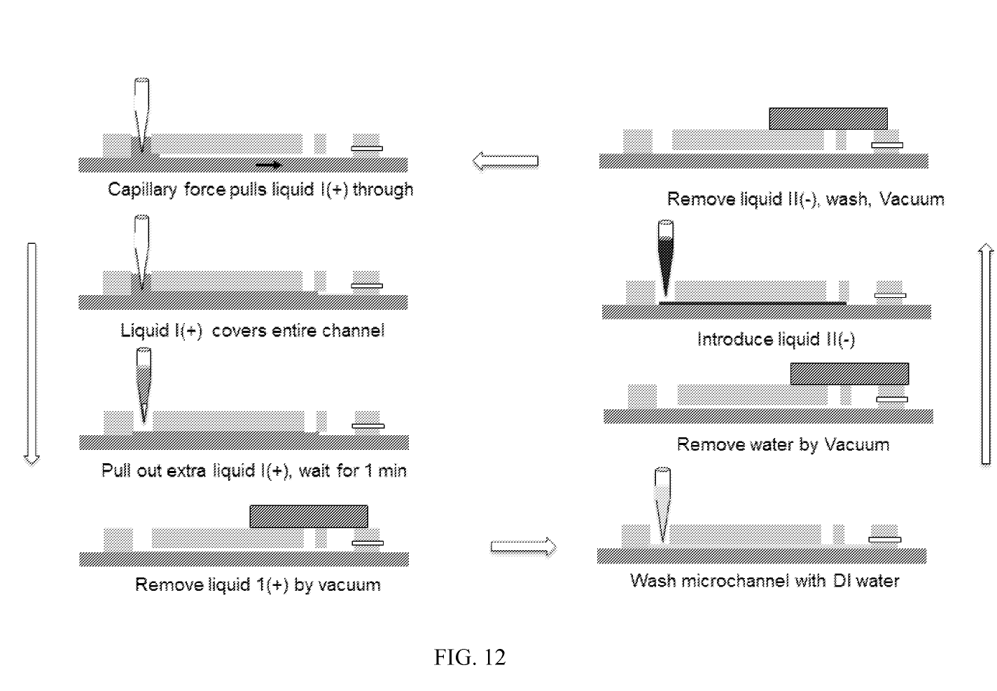

Now referring to FIG. 12, in some embodiments polyelectrolyte solution I (e.g. positive changed species) is first introduced to an inlet (hole 1) by pipet tip of a Liquid Handing (LiHa) Arm, and is subsequently drawn into the channel by capillary force. As the channel is filled with liquid solution, extra polyelectrolyte solution I in the inlet reservoir is pulled out of the device and back into the pipet tip and return to its original container. The capillary force holds the liquid in the channel. The liquid recovery step only removes only liquid solution from the inlet reservoir and leaves the channel covered with polyelectrolyte solution I (the volume of polyelectrolyte solution I inside the microchannel is typically at a nanoliter scale). Polyelectrolyte solution I stays in the channel for a period of time (e.g., 1-60 minutes) for the absorption of PE onto the substrate. The channel is then washed to remove excess non-adsorbed polyelectrolyte. Then a Multi-Channel Analyzer (MCA) head will be guided to cover the outlets (holes 2 and 3), while water remaining in the assembly is removed using a low pressure vacuum or a gas purge to recover an open channel for the adsorption of the next polyelectrolyte. Polyelectrolyte solution II (e.g. negative charged species) is introduced to the channel using the same method described above. In some embodiments, this cycle, the alternating adsorption of two polyelectrolytes, results in a bilayer of polyelectrolyte on the substrate. In some aspects, repeating this process can build films with a designed numbers of bilayers. In some embodiments, the vacuum is constantly displacing during the process. According to some embodiments, the three hole designs ensures that the vacuum pulls off no liquid before the polyelectrolytes are absorbed onto the surface. After completion of building films, alternatively in some aspects, the PDMS sheet can be easily removed from the substrate, leaving the microstrip of LBL film on the substrate, or left in contact with the substrate providing an open channel with all or some sides coated in the built film(s).

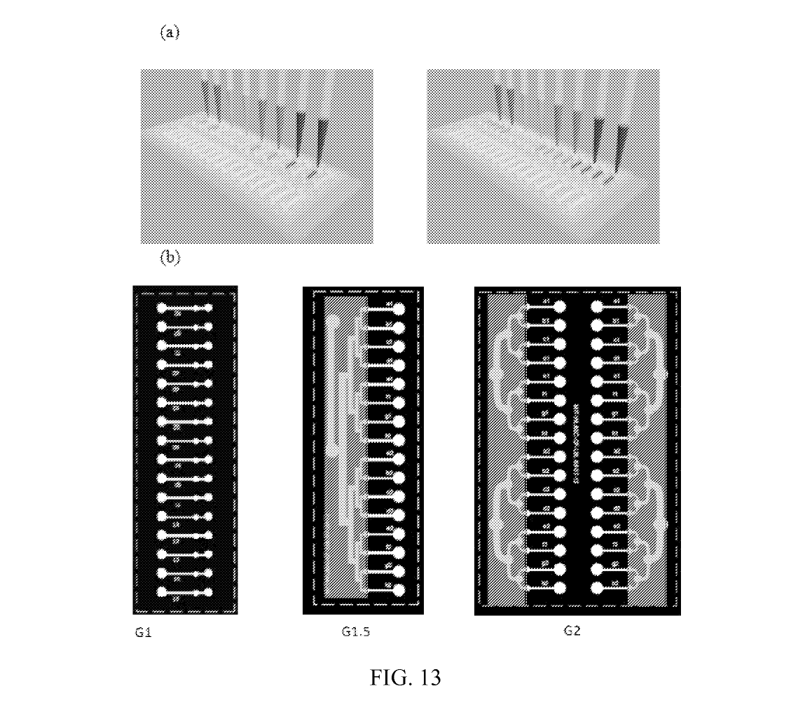

Further referring to FIG. 13(a), inlet reservoirs (hole 1) of each channel are aligned to match the distance between two pipet tips on the Liquid Handing (LiHa) Arm so that the same or different coating materials, such as polyelectrolyte (PE) solutions, can be introduced into multiple channels. In some embodiments, the introduction into multiples channels may be simultaneous or may be completed in separate steps. For example, 32 separate film architectures were built on a single 2″×3″ glass slide using a liquid handling robot, thereby demonstrating programmable and automated capillary force LBL assembly systems in accordance with certain embodiments of the present invention.

According to some embodiments, vacuum lines can be introduced to devices/systems described herein by different methods. In certain embodiments, each individual channel is connected to a thin tube and the tubing is connected by a manifold to a vacuum. In other certain embodiments, an on-chip manifold is connected to each channel as shown in FIG. 13(b). To prevent liquid from one channel flowing into others, in some embodiments, surface of a manifold is selectively modified to be hydrophobic.

Exemplary stencil designs are shown in FIG. 13(b). In some embodiments, a stencil described herein defines multiple channels when the stencil is in operable contact with the substrate. In some embodiments, each channel has an individual vacuum line. In other embodiments, at least some channels of a provided stencil are connected with a single vacuum line. In some embodiments, all channels of a provided stencil are connected with a single vacuum line.

FIG. 13(a) shows parallel microstrips of capillary force LBL films built using a multi pipet from LIHA head illustrative of some embodiments. FIG. 13 (b) shows stencils of some embodiments for integrated creation of 16 or 32 single thin films (each film containing a determined number of layers) on a substrate via capillary force LBL assembly. G1 schematically depicts an exemplary stencil design in which 16 channels are separated; that is, 16 individual vacuum lines are applied through a manifold. G1.5 schematically depicts an exemplary stencil design in which 16 channels are interconnected with an on-chip manifold, wherein the shaded region is modified to be hydrophobic so that material from solution are not deposited thereupon. G2 schematically depicts an exemplary stencil design in which 32 channels are interconnected with an on-chip manifold.

In some embodiments, different coating materials can be used for individual channels and/or for different layers in the same channel. Alternatively in some embodiments, introducing of coating materials into individual channels can be performed concurrently or at different times.

In accordance with the present disclosure, provided methods, devices and systems can be used for any uses/applications. Without being bound to any particular theory, rapid construction of LBL films can be achieved with greater flexibility on a broad range of substrate and for different applications, and the cost of generating a large number of LBL films can be dramatically decreased using the provided methods, devices and systems.

In some embodiments, methods and devices described here use significantly lower volumes of solution than other methods. For example, using methods and devices provided herein, a 100-bilayer film may only requires 200 μL of solution, while existing methods would require in excess of 10 mL for a similar film. This is important for building LBL films with sensitive or expensive materials such as growth factors, cytokines, small molecule drugs, RNA, or DNA, where the solution is expensive or only small amounts are available.

In some embodiments, methods and devices described herein are used to build LBL films in a sterile environment, limiting contamination and allowing more sensitive analysis of film properties not available using normal LBL techniques. In certain embodiments, this also provides the capability for the culture of more sensitive cell lines on these films.

In some embodiments, methods and devices described herein provide the opportunity to build LBL films on a three dimensional structure, which allows for the investigation of the impact of LBL films on a cell microenvironment. For example, LBL films that serve as wells in an assay can be prepared using devices and methods described herein.

In some embodiments, integration of multiple provided devices brings a simple and accessible way to build and investigate films with varied compositions, morphology and architectures rapidly. In certain embodiments, this technology allows for the screening of film properties in a high throughput manner.

In some embodiments, methods, devices and systems described here are fully automated using a programmable computer-assisted liquid handling robot.

It is contemplated in this present disclosure that the technology described herein provides a solution to many of key challenges for the translation of multilayer assembly to industrial applications. For example, rapid construction of LBL films can be achieved with greater flexibility on a broad range of substrates and surfaces, and the cost of generating a large number of LBL thin films can be dramatically decreased using high throughput microstrip arrays. Exemplary applications includes the manufacture of LBL microstrip arrays for high throughput screening of LBL assemblies, as well as the assembly of “lab-on-a-chip” devices where LBL films can be used to investigate sensitive biological and chemical systems.

### Experimental Examples

### Cell Culture and Analysis

Cells cultures deposited on or associated with the films as described herein were seeded at an initial density of 1 M/mL and allowed to settle for 1 hour after which media was exchanged to remove unattached cells. All cell lines were cultured in Advanced-MEM with 5% FBS and 1% Pen-Strep and 2 mM L-glutamine. Media was exchanged daily by placing a droplet at the inlet and removing the waste at the exit of the microchannels.

Phase contrast and fluorescent images were taken daily and were performed using a Zeiss Axiovert 200 microscope. Confocal imaging was done using a Nikon 1AR Ultra-Fast Spectral Scanning Confocal Microscope and three-dimensional projection was created using Velocity software. Cell areas and number were determined from phase contrast imaging and analysis was performed by hand using ImageJ. Fraction GFP positive cells was calculated from fluorescent images by hand setting a threshold of 5 times background fluorescence with a 500 ms exposure time.

pH-Dependent Thickness Behavior of PAA/PAH Films:

pH dependent experiments were performed to confirm that the devices and methods of the present invention and described herein produced thin films that are comparable or superior to films produced by previous methods, such as via dipping. Further, these experiments also emphasized the significance of the role that solution pH plays in layer-by-layer processing of weak polyelectrolytes.

Screening of LBL film libraries may be readily performed using the devices and methods of the present invention. To demonstrate the capability of CF-LBL in this regard, Professor Rubner's classic experiment was recreated. Poly(acrylic acid) (PAA) and poly(allylamine hydrochloride) (PAH) were deposited by CF-LBL. PAA/PAH bilayer films were made using polymer solutions that ranged in pH from 2.5 to 9.0.

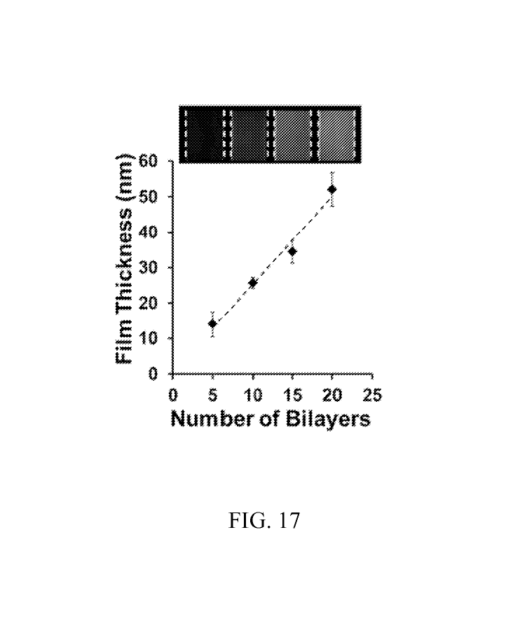

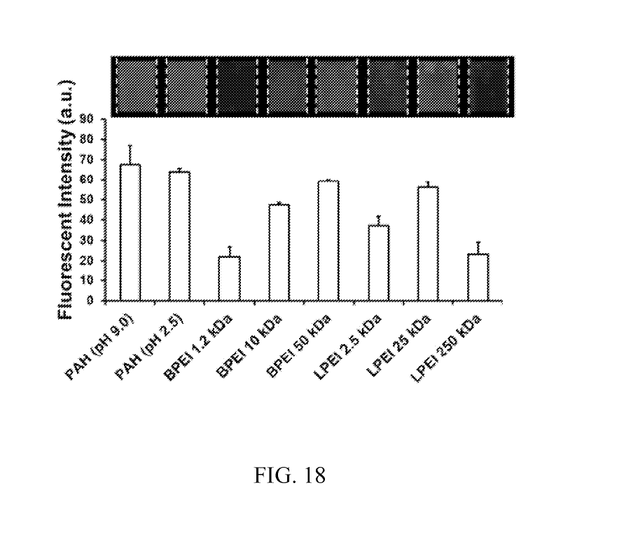

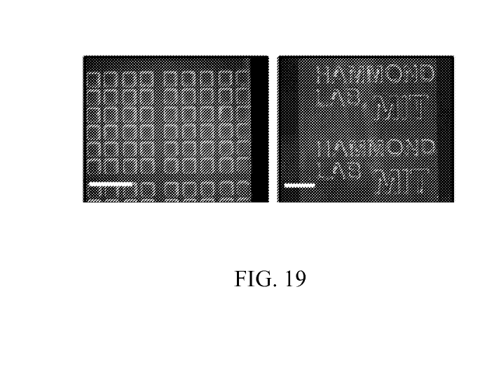

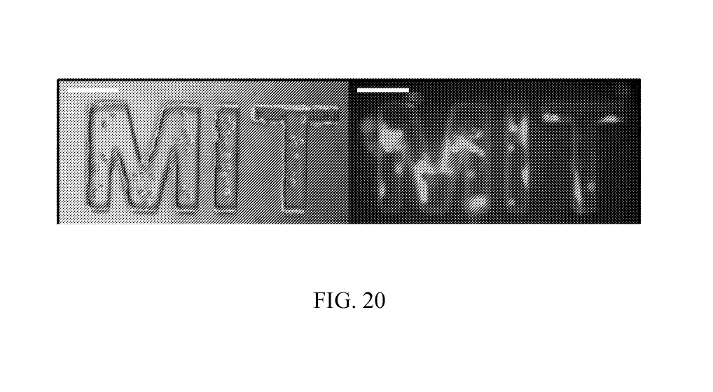

The physical characteristics of the films formed within the device were measured using ellipsometry or profilometry as well as by Atomic Force Microscopy. For example, FIG. 17 shows correlation between the number of LBL bilayer films deposited and the resultant film thickness measured. Specifically, FIG. 17 shows a correlation between film thickness and the number of bilayers for a sample of PAA/PAH_{FITC} LBL film. Referring to FIG. 18 fluorescently labeled material was followed using either microscopy or other existing imaging modalities. As discussed in more detail below, the materials compared within this graph vary with pH or molecular weight. The graph of FIG. 18 demonstrates the precision and control of films deposited using CF-LBL. Moreover, this confirms CF-LBL thin film deposition offers all the benefits of LBL deposition with minimal material waste at levels not previously accomplished. Further referring to FIG. 19 and FIG. 20, microstructures can be incorporated within the channels to increase surface area and to influence cell seeding and surface interactions. FIG. 19 demonstrates patterned microstructures within the channel are capable using CF-LBL. Additionally, FIG. 20 shows a micro-patterned surface within the channel may be used for direct cell seeding.

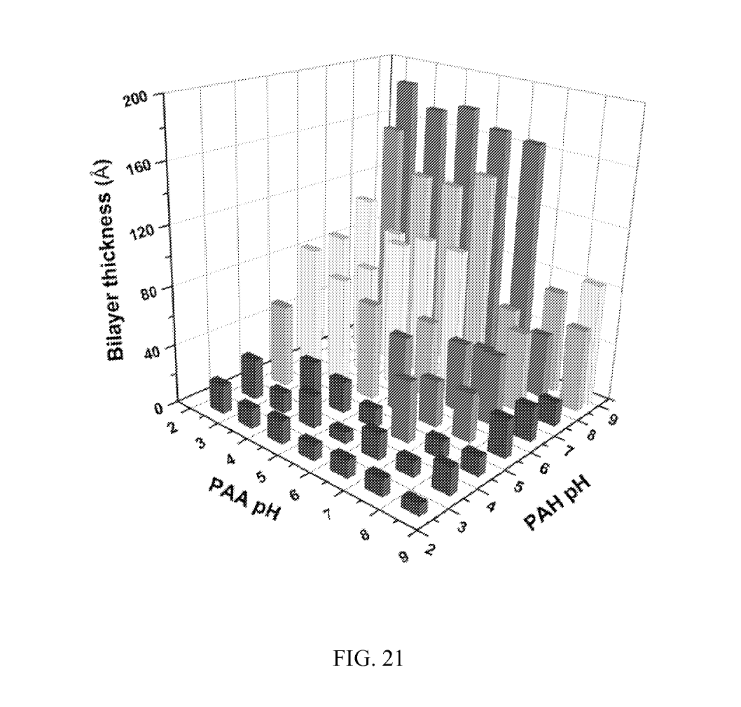

Thickness of the resultant LBL films was measured and is shown in FIG. 21 to have pH-dependent thickness behavior of sequentially absorbed layers of weak polyelectrolytes and investigation of in vitro cell interactions on polyelectrolyte multilayer (PEM) thin films. In comparison to the more classic dip-LBL methods, the trends shown for CF-LBL are similar to those reported for films built by dip-LBL apparatus and methods. Specifically, by altering the pH of the relevant adsorption solution, thereby increasing the degree of ionization of either PAA or PAH led to decreased average bilayer thickness. As an example when PAA of pH 2.5 was built with either PAH at pH 2.5 or 9.0, the former was only 18 Å/bilayer while the latter was more than 10 times as thick per bilayer (190 Å/bilayer).

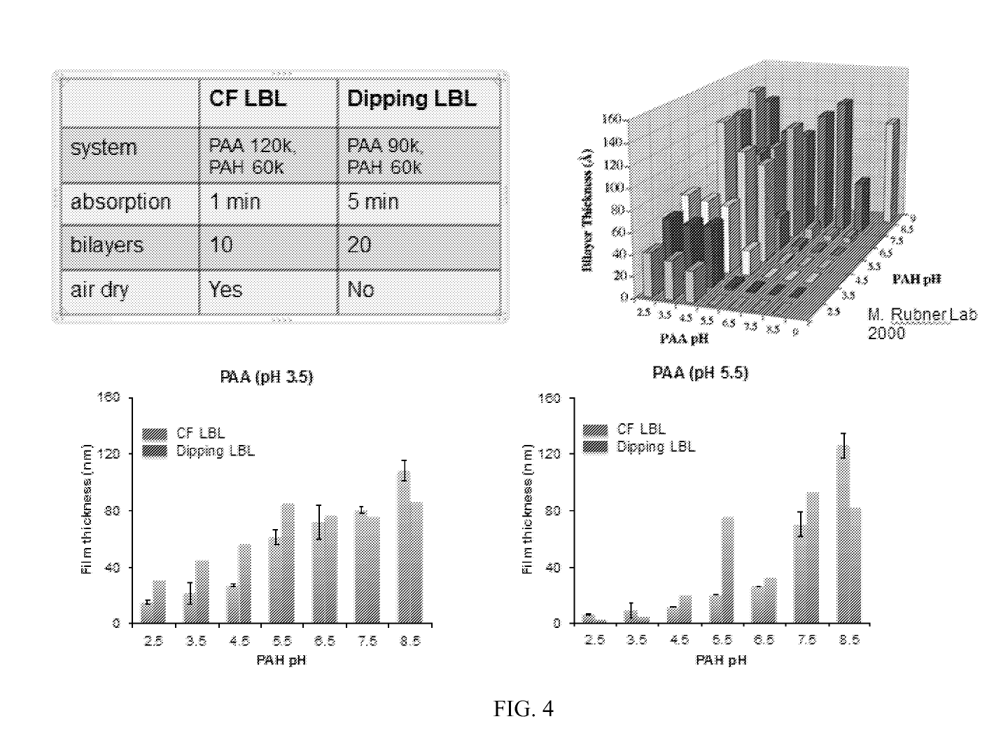

In comparison, a dipping method experiment was also conducted according to the original work carried out in Prof M. F Rubner's lab (Shiratori and Rubner, Macromolecules 2000, 33, 4213-4219). FIG. 4 illustrates a comparison of LBL films fabricated using CF-LBL methods/devices provided herein with films fabricated by a conventional dipping method. Referring to the figure, film thickness is plotted for films made by each method as a function of solution pH. The figure in the upper right corner of FIG. 4 is a complete pH matrix showing the average incremental thickness contributed by a PAH/PAA bilayer as a function of dipping solution pH. As shown by FIG. 4 and as compared to the previously reported results (for pH of PAA=3.5 and 4.5), the same trend of film thickness change according to different pH of PAH solution was observed. The two figures on the bottom confirmed the same pH-dependent thickness behavior of PAA/PAH films fabricated using a CF-LBL method according to the present invention.

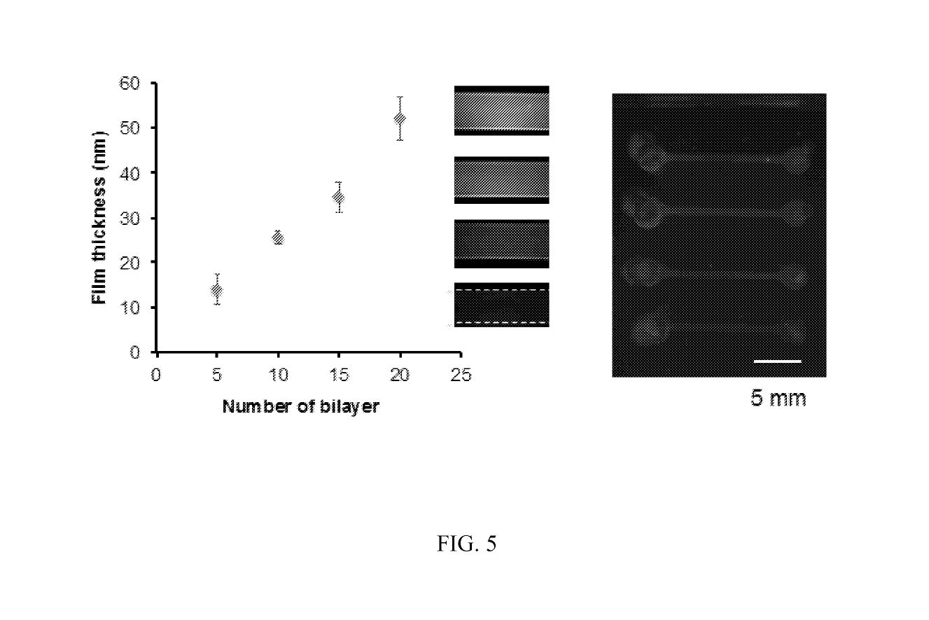

It was also observed at some specific pH value (e.g., PAA 5.5, PAH 5.5), that a much thicker LBL film can be made than that made by dipping. FIG. 5 demonstrates the correlation between film thickness and the number of bilayers of a thin film prepared according to an embodiment. The growth curve shown in FIG. 5 indicates that the films built in a CF-LBL manner demonstrated almost linear increasing film thickness with increasing numbers of bilayers. This was confirmed using florescent dye linked to one of the building polymers, PAH in this case. Specifically, increasing film thickness was observed corresponding to enhanced fluorescent intensity. Accounting for the different absorption times that may be used, it is possible that the provided methods and devices herein can be used to study the kinetics of the rearrangement of polymer chains in LBL films.

### Cell Adhesion and Viability on CF-LbL Thin Films

Previous reports using either dip-LBL or other deposition techniques have described how altering the deposition conditions of weak polyelectrolytes in layer-by-layer assemblies can yield different surface characteristics and mechanical properties, thereby affecting how cells on them and associated with them will behave.

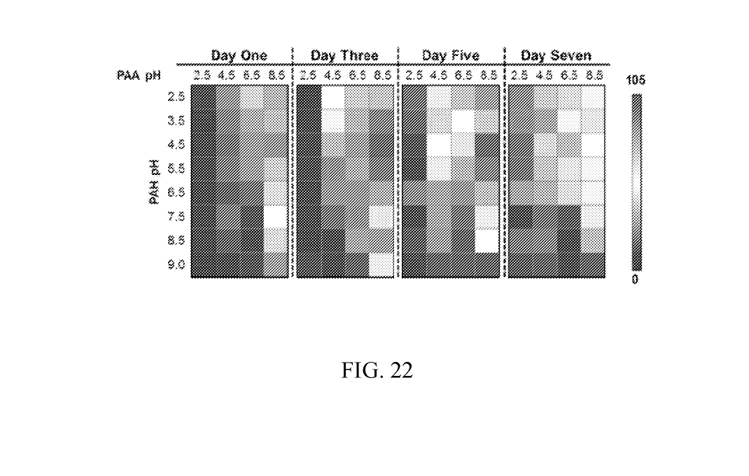

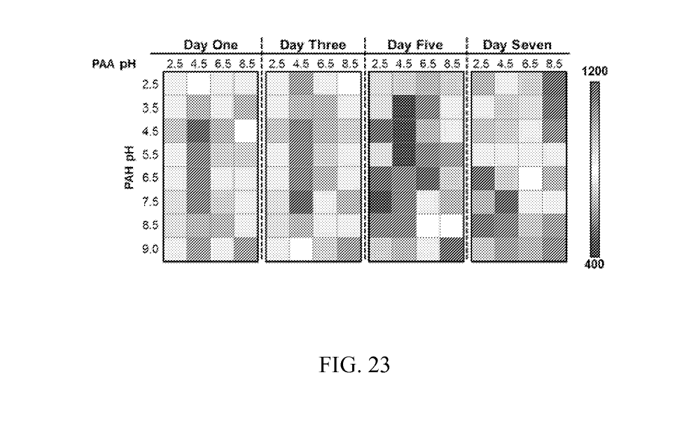

The devices and methods described herein for CF-LBL allow for the sensitive analysis of film properties including the extensive study of cell behavior and morphology on polyelectrolyte multilayers. NIH-3T3 cells were cultured on 32 different film architectures over a wide range of assembly conditions. Cell attachment and cell spreading on the surface were measured daily using phase contrast light microscopy with NIH image processing software, ImageJ as shown by FIG. 22 and FIG. 23. FIG. 22 cells were initially seeded at 0.1 M/ml, the graph demonstrates cell density on films measured over time and with varying pH levels for the PAA and PAH layers. Similarly, the graph shown in FIG. 23 exhibits the average spread area of the cells on these different film architectures.

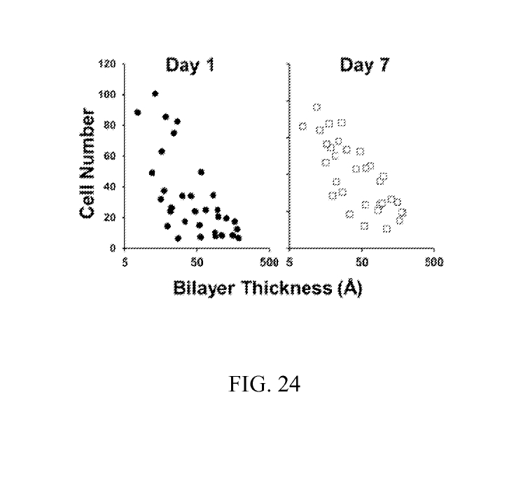

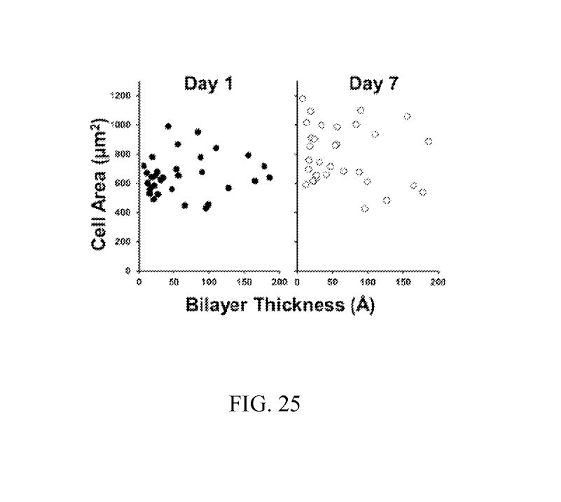

FIG. 24 depicts a pair of graphs illustrating the effect of film thickness on cell density. Increasing bilayer thickness resulted in a decrease in total cell number as shown in FIG. 24. That is, increasing bilayer thickness negatively impacted the total number of cells which initially seeded on the films. FIG. 25 a pair of graphs showing plot of cell spread area vs. bilayer thickness. And bilayer thickness was shown to have little impact on cell spread area.

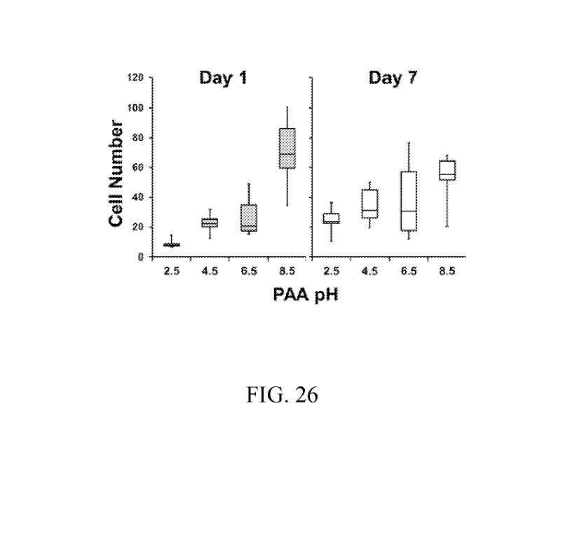

In contrast, referring to FIG. 26, varying the pH of the polymer solutions had a substantial impact on cell number. Solutions of PAA (0.01 M) and PAH (0.01 M) were used to build LBL films. Eight different films (10 bilayers) were built in 1.5 hours, using the inventive method described herein with less than 1 mL solution. In this case, the pH of PAA was shown to have a significant impact on cell density and had a far greater impact than pH of PAH. These findings closely resemble those presented in previous reports for the PAA/PAH LBL system for other cell lines.

### DNA Transfection by High Molecular Weight Polyelectrolytes:

Delivery of nucleic acids from LBL film surfaces provides a simple approach to alter local gene expression in a sustained way and could provide new opportunities in fields ranging from fundamental molecular biology to tissue engineering. Due to the complex factors that impact DNA packaging and transfection identification of potential LBL systems can most effectively be done in a high-throughput manner. To confirm the capability of CF-LBL to screen film libraries, 16 different film architectures for the non-viral delivery of plasmid DNA from LBL surfaces were investigated.

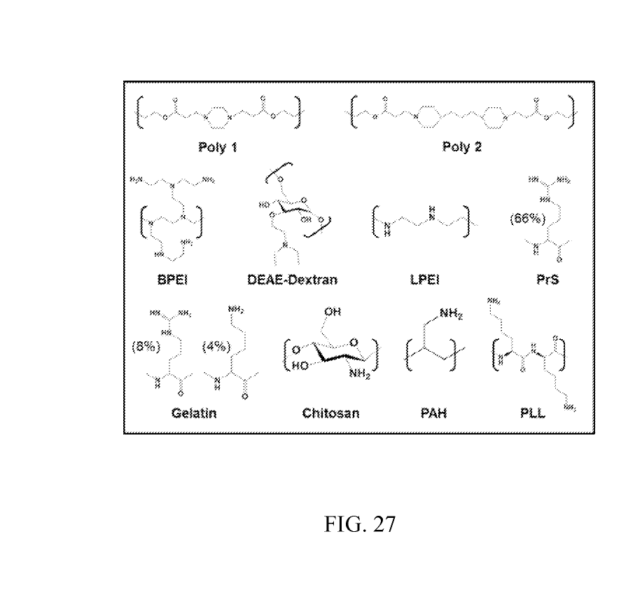

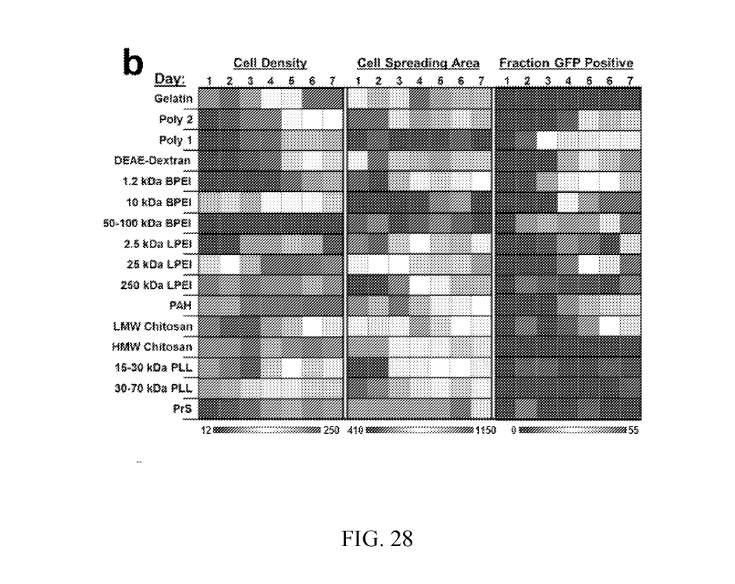

The table of FIG. 27 shows the range of materials investigated and used to achieve DNA transfection, including 1°, 2°, and 3° amines. Cells were directly seeded onto the films within the device after film assembly. And as shown by FIG. 28 the cells and films were monitored for fraction GFP expression, cell density, and average cell spread area of DNA transfection of cells over one week.

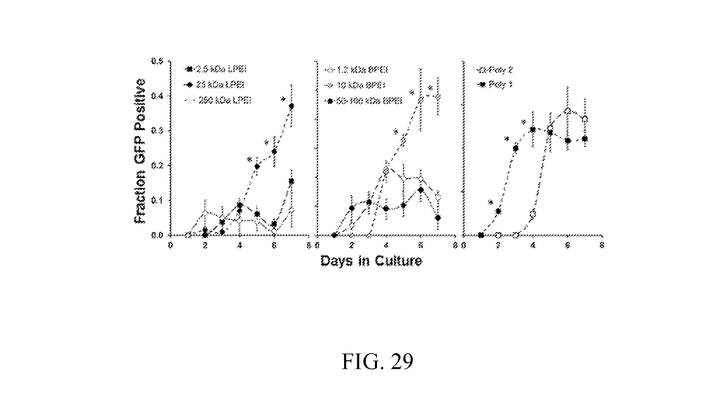

Referring to FIG. 29, both the behavior of cells on the LBL film surface as well as the transfection efficacy were significantly impacted by polycation molecular weight. FIG. 29 shows a set of graphs of cells deposited on (BPEI/pEGFP) films cultured within the microchannels after 5, 6, and 7 days of culture. Polymers which contain only primary amines were far less successful at transfecting cells than those with secondary and tertiary amines. In the fraction of cells successfully transfected, there was no correlation to cell spreading area or cell number.

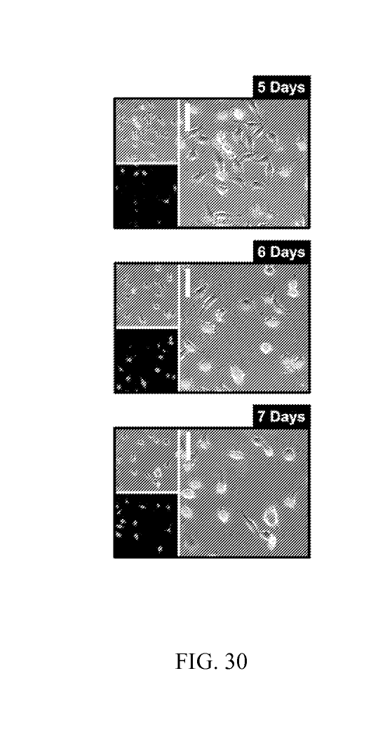

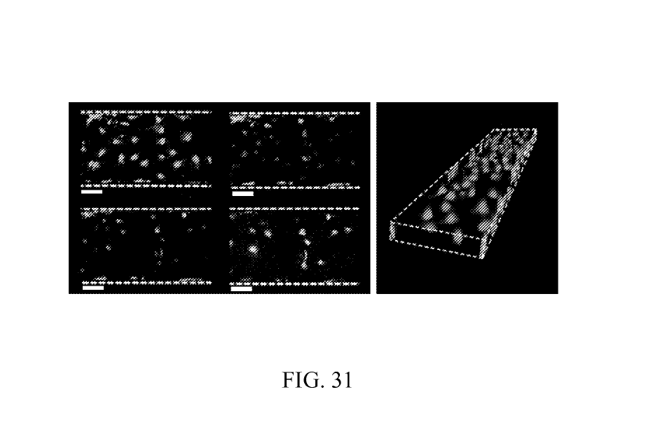

Previously, coating of the interior of a microchannel with fibronectin to promote 3D cell culture on the channel walls has been reported. From the screen of 16 films and as illustrated in FIG. 30, 10 kDa BPEI was chosen as the best performing architecture. cells FIG. 31 shows cells cultured on all four sides of a channel coated with the CF-LBL film by rotating the device while cells are being seeded. Importantly, as demonstrated by FIG. 31, CF-LBL films obtain similar results to other classic techniques. Specifically, the ability of these devices and methods to deliver incorporated material effectively to those cells.

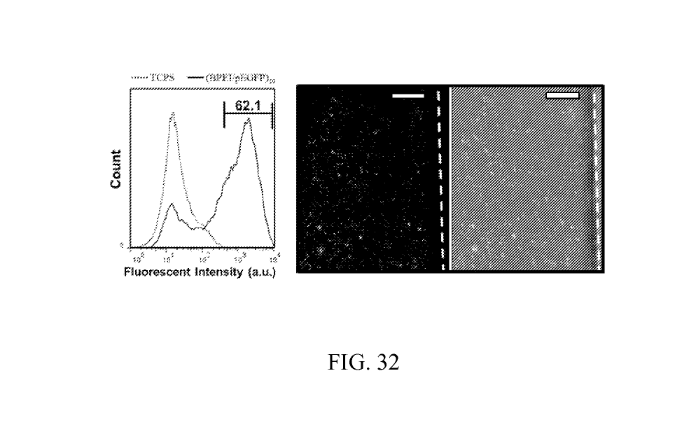

Finally, 10 kDa BPEI were applied onto a 3″×1″ microscope slides. Further, as depicted in FIG. 32, the flow cytometry of cells cultured on the film for seven days showed over sixty percent of cultured cells were GFP positive.

High-throughput assembly and screening of LBL films using capillary flow mechanisms and liquid handling equipment may simultaneously create hundreds of LBL films using only microliters of material solutions for the high-throughput screening of LBL film libraries. Using devices and methods of the present invention successful reproduction of the well-established studies of weak polyelectrolytes, cell adhesion and viability on LBL thin films, and the investigation of a library of films for the delivery of DNA for transfection from surfaces. Devices and methods produced these films using minimal materials thereby reducing waste while providing a sterile environment within which biological, chemical, or electrochemical assays can be performed on each film independently. Additionally, analysis of cell behavior on film surfaces was readily assessed in a high-throughput manner using motorized stages microscopy as well as programmable mechanical testing equipment.

While the invention has been particularly shown and described with reference to specific preferred embodiments, it should be understood by those skilled in the art that various changes in form and detail may be made therein without departing from the spirit and scope of the invention as defined by the appended claims.

1. A device for depositing at least one layer of a coating material onto a substrate, the device comprising:
an assembly configured to form one or more channels when the device is in operable contact with the substrate, each channel having an inlet at one end by which the coating material is introduced into the channel, wherein each channel is a lengthwise enclosure defined by a surface of the substrate on one side and one or more adjacent structures of the assembly surrounding the channel along its length.

2. The device of claim 1, wherein at least one of the one or more channels has a volume no more than 10 microliters.

3. The device of claim 1, wherein at least one of the one or more channels has an average smallest dimension of less than 1000 microns.

4. The device of claim 3, wherein the smallest dimension is width.

5. The device of claim 3, wherein the smallest dimension is height.

6. The device of claim 1, wherein each of the one or more channels further has an outlet at an end opposite the inlet.

7. The device of claim 1, wherein at least one of the one or more channels comprises one or more walls that are non-flat.

8. The device of claim 1, wherein at least one of the one or more channels comprises one or more walls that are patterned.

9. The device of claim 8, wherein the one or more patterned walls comprises posts and/or wells.

10. The device of claim 8, wherein the one or more patterned walls comprises one or more microstructures.

11. The device of claim 1, wherein the assembly comprises at least one material selected from the group consisting of glass, polymer, co-polymer, urethanes, rubber, molded plastic, polymethyl-methacrylate (PMMA), polycarbonate, polytetrafluoroethylene (PTFE/TEFLON®), polyvinylchloride (PVC), polymethylsiloxane (PDMS), and polysulfone.

12. A method for depositing at least one layer of a first coating material on a substrate, comprising:
contacting a device with the substrate, wherein the device comprises an assembly configured to form one or more channels, each channel having an inlet at one end by which the first coating material is introduced into the channel, wherein each channel is a lengthwise enclosure defined by a surface of the substrate on one side and one or more adjacent structures of the assembly surrounding the channel along its length; and
introducing the first coating material into the one or more channels to produce a first layer of the coating material on the surface of the substrate.

13. The method of claim 12, further comprising maintaining the first coating material in the one or more channels in contact with the surface of the substrate for a predetermined time period.

14. The method of claim 13, wherein the predetermined time period is from about 1 minute to about 30 minutes.

15. The method of claim 13, wherein the predetermined time period is up to about 1 hour.

16. The method of claim 12, further comprising removing an excess amount of the first coating material from the one or more channels.

17. The method of claim 16, wherein removing the excess amount of the first coating material is performed by introducing air into the channel or by applying a vacuum.

18. The method of claim 17, wherein the vacuum is less than about 15 psi, about 10 psi or about 5 psi.

19. The method of claim 12, further comprising introducing a second coating material via the inlet into the one or more channels to produce a second layer in contact with the first layer.

20. The method of claim 19, wherein the first and second coating materials are associated with one another via one or more non-covalent interactions.

21. The method of claim 20, wherein the one or more non-covalent interactions are selected from the group consisting of electrostatic interactions, hydrogen bonding, affinity, metal coordination, physical adsorption, host-guest interactions, hydrophobic interactions, pi stacking interactions, van der Waals interactions, magnetic interactions, dipole-dipole interactions and combinations thereof.

22. The method of claim 19, further comprising repeating the introduction of the first coating material into the one or more channels and, subsequently, repeating the introduction of the second coating material into the one or more channels, thereby forming a thin film comprising two bilayers on the substrate.

23. A device for preparing an array of thin films via layer-by-layer assembly, the device comprising:
a stencil configured to form multiple channels when the stencil is in operable contact with a substrate, wherein each channel has an inlet at one end by which coating material can be introduced into the channel, each channel has an outlet at an end opposite the inlet from which coating material may be drawn or may exit the channel, and each channel is a lengthwise enclosure defined by a surface of the substrate on one side and by one or more adjacent structures of the stencil surrounding the channel along its length; and
a plurality of heads spaced in relation to each other to enable simultaneous or near-simultaneous introduction of coating material via the inlets into the plurality of channels formed when the stencil is in operable contact with the substrate.

24. The device of claim 23, further comprising:
a robotic arm; and
a programmable controller configured to direct one or more of the following actions of the robotic arm: manipulation of peripheral labware, introduction of solution into the multiple channels via the plurality of channel heads, and extraction of solution from one or more of the multiple channels via the channel outlets.

25. The device of claim 23, wherein a plurality of the channel outlets are connected to a common outlet reservoir.

26. The device of claim 25, further comprising a vacuum line connected to the common outlet reservoir for extraction of solution from the corresponding channels via vacuum.

27. The device of claim 23, wherein the stencil comprises at least one material selected from the group consisting of glass, polymer, co-polymer, urethanes, rubber, molded plastic, polymethyl-methacrylate (PMMA), polycarbonate, polytetrafluoroethylene (PTFE/TEFLON®), polyvinylchloride (PVC), polymethylsiloxane (PDMS), and polysulfone.

28. The device of claim 23, wherein each channel has a volume no more than about 10 microliters from inlet to outlet.

29. The device of claim 23, wherein each channel has an average width and/or depth of no more than about 1000 microns.

30. The device of claim 23, wherein the plurality of heads comprises pipette heads.

31. The device of claim 23, wherein the plurality of heads comprises 8, 16, 32, 96, or 384 heads.

32. A stencil configured to form multiple channels when the stencil is in operable contact with a substrate for preparation of a plurality of layered thin films on the substrate via LBL assembly, wherein each channel has an inlet at one end by which coating material can be introduced into the channel, and wherein each channel is a lengthwise enclosure defined by a surface of the substrate on one side and by one or more adjacent structures of the stencil surrounding the channel along its length.

33. The stencil of claim 32, wherein the stencil comprises at least one material selected from the group consisting of glass, polymer, co-polymer, urethanes, rubber, molded plastic, polymethyl-methacrylate (PMMA), polycarbonate, polytetrafluoroethylene (PTFE/TEFLON®), polyvinylchloride (PVC), polymethylsiloxane (PDMS), and polysulfone.

34. The stencil of claim 32, wherein each channel has an outlet at an end opposite the inlet, and wherein a plurality of the outlets are connected.

35. The stencil of claim 32, wherein each channel has a volume no more than about 10 microliters.

36. The stencil of claim 32, wherein each channel has an average width and/or depth of no more than about 1000 microns.

37. A method for preparing an array of thin films via layer-by-layer assembly, the method comprising:
contacting a stencil with a substrate, wherein the stencil is configured to form multiple channels when the stencil is in operable contact with the substrate, wherein each channel has an inlet at one end by which coating material is introduced into the channel, each channel has an outlet at an end opposite the inlet from which coating material is drawn or exits the channel, and each channel is a lengthwise enclosure defined by a surface of the substrate on one side and by one or more adjacent structures of the stencil surrounding the channel along its length;
introducing a first coating material into the multiple channels via a plurality of heads spaced in relation to each other to enable simultaneous or near-simultaneous introduction of coating material via the inlets into the plurality of channels formed when the stencil is in operable contact with the substrate, in order to deposit a first layer of the coating material in an array of individual strips on the surface of the substrate;
removing an excess amount of the first coating material from the multiple channels;
maintaining the first coating material in the multiple channels in contact with the surface of the substrate for a predetermined time period;
after maintaining the first coating material in the channels for the predetermined time period, removing an amount of the first coating material from the multiple channels via the outlets;
washing the plurality of channels by introducing a washing fluid into the multiple channels and drawing the washing fluid out of the channels;
introducing a second coating material into the multiple channels via a plurality of heads to deposit a second layer in contact with the first layer for each of the individual strips in the array, wherein the first and second coating materials are associated with one another via one or more non-covalent interactions;
removing an excess amount of the second coating material from the multiple channels;
maintaining the second coating material in the multiple channels in contact with the previously-deposited first coating material for a predetermined period of time, in order to form an array of thin bi-layer films on the substrate; and
after maintaining the second coating material in the channels for the predetermined time period, removing an amount of the second coating material from the multiple channels via the outlets.

38. The method of claim 37, further comprising repeating the introduction of the first coating material into the plurality of channels and, subsequently, repeating the introduction of the second coating material into the plurality of channels, thereby forming thin films in the array comprising two bilayers on the substrate.

39. The method of claim 37, wherein the array of thin films on the substrate are configured to form a lab-on-a-chip biological and/or chemical assay product.

40. The method of claim 37, comprising directing a robotic arm to perform one or more of the following actions; manipulate peripheral labware, introduce solution into the multiple channels via the plurality of channel heads, extract solution from one or more of the multiple channels via the channel outlets.

41. The method of claim 37, wherein removing the amount of the first coating material via the outlets is performed by introducing air into the channels or by applying a vacuum.

42. The method of claim 37, wherein the stencil comprises at least one material selected from the group consisting of glass, polymer, co-polymer, urethanes, rubber, molded plastic, polymethyl-methacrylate (PMMA), polycarbonate, polytetrafluoroethylene (PTFE/TEFLON®), polyvinylchloride (PVC), polymethylsiloxane (PDMS), and polysulfone.

43. A method for preparing an array of thin films via layer-by-layer assembly, the method comprising:
contacting a stencil with a substrate, wherein the stencil is configured to form multiple channels when the stencil is in operable contact with the substrate, wherein each channel has an inlet at one end by which coating material is introduced into the channel, each channel has an outlet at an end opposite the inlet from which coating material is drawn or exits the channel, and each channel is a lengthwise enclosure defined by a surface of the substrate on one side and by one or more adjacent structures of the stencil surrounding the channel along its length;
introducing a first coating material into the multiple channels via a plurality of heads spaced in relation to each other to enable simultaneous or near-simultaneous introduction of coating material via the inlets into the plurality of channels formed when the stencil is in operable contact with the substrate, thereby producing a first layer of the coating material in an array of individual strips on the surface of the substrate;
maintaining the first coating material in the multiple channels in contact with the surface of the substrate for a predetermined time period;
introducing a second coating material into the multiple channels via a plurality of heads to produce a second layer in contact with the first layer for each of the individual strips in the array; and
maintaining the second coating material in the multiple channels in contact with the previously-deposited first coating material for a predetermined period of time, thereby forming an array of thin bi-layer films on the substrate.

44. The method of claim 43, wherein the first coating material introduced into the multiple channels has a composition which varies among the individual channels.
